(19) United States
(12) Patent Application Publication
(10) Pub. No.: US 2025/0119249 A1
(43) Pub. Date: Apr. 10, 2025

(54) COMMUNICATION METHODS AND TERMINAL DEVICE

(71) Applicant: GUANGDONG OPPO MOBILE TELECOMMUNICATIONS CORP., LTD., Dongguan (CN)

(72) Inventor: Nande ZHAO, Dongguan (CN)

(21) Appl. No.: 18/985,293

(22) Filed: Dec. 18, 2024

Related U.S. Application Data
(63) Continuation of application No. PCT/CN2022/113724, filed on Aug. 19, 2022.

(51) Int. Cl. H04L 5/00; H04W 72/232

(52) U.S. Cl. CPC H04L 5/0044; H04W 72/232

(57) ABSTRACT

A method for communication includes that: a terminal device receives system information, where the system information carries first indication information; the terminal device receives downlink control information (DCI) for scheduling a physical downlink shared channel (PDSCH), and the terminal device receives, based on at least one of the first indication information or the DCI, the PDSCH for which transport block size (TBS) scaling is performed. A method for communication performed by a network device, and a terminal device are also provided.

### CROSS-REFERENCE TO RELATED APPLICATION

This application is a continuation application of International Application No. PCT/CN2022/113724, entitled “COMMUNICATION METHOD, APPARATUS, AND DEVICE, STORAGE MEDIUM, CHIP, PRODUCT, AND PROGRAM” and filed on Aug. 19, 2022, which is incorporated herein by reference in its entirety.

### TECHNICAL FIELD

Embodiments of the present disclosure relate to the technical field of mobile communications, and particularly to methods for communication, and a terminal device.

### BACKGROUND

A terminal device and a network device can use a transport block (TB) to transmit information during communication. However, in downlink transmission, how the terminal device receives a physical downlink shared channel (PDSCH) for which transport block size (TBS) scaling is performed has always been a concern in this field.

### SUMMARY

Embodiments of the present disclosure provide methods for communication, and a terminal device.

In a first aspect, a communication method is provided, which includes the following operations.

A terminal device receives system information. Herein the system information carries first indication information.

The terminal device receives downlink control information (DCI) for scheduling a physical downlink shared channel (PDSCH).

The terminal device receives, based on the first indication information and/or the DCI, the PDSCH for which transport block size (TBS) scaling is performed.

In a second aspect, another communication method is provided, which includes the following operations.

A network device sends system information. Herein the system information carries first indication information.

The network device sends downlink control information (DCI) for scheduling a physical downlink shared channel (PDSCH).

Herein the first indication information and/or the DCI is used for a terminal device to receive the PDSCH for which transport block size (TBS) scaling is performed.

In a third aspect, a terminal device is provided, which includes a processor and a memory.

The memory stores a computer program executable by the processor.

The processor, when executing the program, performs the method in the first aspect.

### BRIEF DESCRIPTION OF THE DRAWINGS

The accompanying drawings illustrated herein are used to provide a further understanding of and constitute a part of the present disclosure, and the illustrative embodiments of the present disclosure and the description thereof are used to explain the present disclosure and do not constitute an undue limitation on the present disclosure, and wherein:

FIG. 1 is a schematic diagram of an application scenario of an embodiment of the present disclosure;

FIG. 2 is a schematic architecture diagram of a communication system provided by an embodiment of the present disclosure;

FIG. 3 is a schematic architecture diagram of another communication system provided by an embodiment of the present disclosure;

FIG. 4 is a schematic diagram of an NTN scenario based on a transparent payload satellite provided by an embodiment of the present disclosure;

FIG. 5 is a schematic diagram of an NTN scenario based on regenerative payload satellites provided by an embodiment of the present disclosure;

FIG. 6 is a schematic flowchart of a communication method provided by an embodiment of the present disclosure;

FIG. 7 is a schematic flowchart of another communication method provided by an embodiment of the present disclosure;

FIG. 8 is a schematic flowchart for a UE receiving a TBS scaling factor provided by an embodiment of the present disclosure;

FIG. 9 is a schematic flowchart for a UE performing TBS scaling for a PDSCH provided by an embodiment of the present disclosure;

FIG. 10 is a first schematic structural composition diagram of a communication apparatus provided by an embodiment of the present disclosure;

FIG. 11 is a second schematic structural composition diagram of a communication apparatus provided by an embodiment of the present disclosure;

FIG. 12 is a schematic structural diagram of a communication device provided by an embodiment of the present disclosure; and

FIG. 13 is a schematic structural diagram of a chip of an embodiment of the present disclosure.

### DETAILED DESCRIPTION

The technical solution of embodiments of the present disclosure will be described in conjunction with the accompanying drawings in embodiments of the present disclosure below, and it will be apparent that the described embodiments are part of embodiments of the present disclosure, but not all of them. Based on embodiments in the present disclosure, all other embodiments obtained by those ordinarily skilled in the art without making creative efforts fall within the scope of protection of the present disclosure. The technical solutions described in embodiments of the present disclosure can be combined arbitrarily without conflict. In the description of the present disclosure, the meaning of “multiple” refers to two or more, unless otherwise specifically limited.

The communication system scenarios include a terrestrial network (TN) and a non-terrestrial network (NTN). Here, the NTN may provide communication services to ground users by means of satellite communication. The NTN system may include new radio (NR)-NTN and internet of things (IoT)-NTN systems.

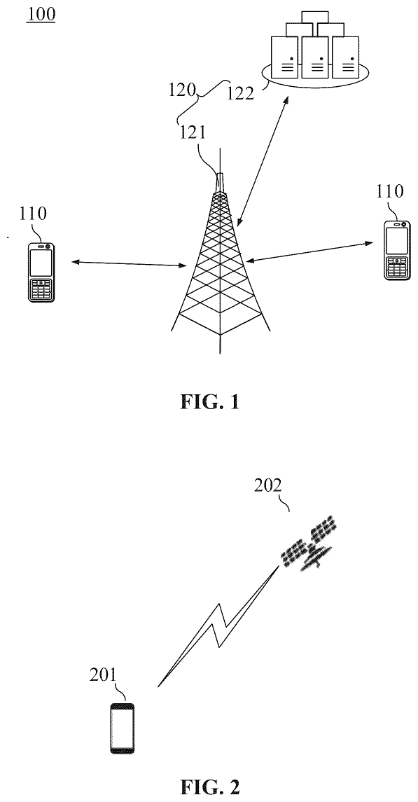

FIG. 1 is a schematic diagram of an application scenario of an embodiment of the present disclosure. As illustrated in FIG. 1, a communication system 100 may be a terrestrial network system, and the communication system 100 may include a terminal device 110 and a network device 120. The network device 120 may communicate with the terminal device 110 through an air interface. Multi-service transmission is supported between the terminal device 110 and the network device 120.

It should be understood that embodiments of the present disclosure are only illustrated by the communication system 100 as an example, but are not limited thereto. That is to say, the technical solutions of embodiments of the present disclosure may be applied to various communication systems, such as: a global system of mobile communication (GSM) system, a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of NR system, a LTE-based access to unlicensed spectrum (LTE-U) system, a NR-based access to unlicensed spectrum (NR-U) system, a universal mobile telecommunication system (UMTS), a wireless local area network (WLAN), wireless fidelity (WiFi), a LTE time division duplex (TDD) system, a universal mobile telecommunication system (UMTS), an internet of things (IoT) system, a narrow band internet of things (NB-IoT) system, an enhanced machine-type communication (eMTC) system, or a future communication system (such as 6G, 7G, or another communication system), etc.

The network device 120 in the embodiment of the present disclosure may include an access network device 121 and/or a core network device 122. The access network device may provide communication coverage for a particular geographic area and may communicate with a terminal device 110 (such as user equipment (UE)) located within the coverage area.

The terminal device in any embodiment of the present disclosure is a device with wireless communication function, which may be deployed on land, including indoor or outdoor, hand-held or vehicle-mounted; may be deployed on the water (such as ships, etc.); may also be deployed in the air (such as airplanes, balloons and satellites, etc.). The terminal device in any embodiment of the present disclosure may be referred to as a user equipment (UE), a mobile station (MS), a mobile terminal (MT), a user unit, a user station, a mobile station, a remote station, a remote terminal, a mobile device, a user terminal, a terminal, a wireless communication device, a user agent, or a user device, etc. The terminal device may include one or a combination of at least two of the following: an internet of things (IoT) device, a satellite terminal, a wireless local loop (WLL) station, a personal digital assistant (PDA), a handheld device with wireless communication capabilities, a computing device or other processing devices connected to a wireless modem, a server, a mobile phone, a pad, a computer with wireless transmission and reception capabilities, a handheld computer, a desktop computer, a personal digital assistant, a portable media player, a smart speaker, a navigation apparatus, a smartwatch, smart glasses, a smart necklace and other wearable devices, a pedometer, a digital TV, a virtual reality (VR) terminal device, an augmented reality (AR) terminal device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, as well as a vehicle in a vehicle networking system, an onboard device, an onboard module, a wireless modem, a handheld device, customer premise equipment (CPE), or a smart home appliance.

In an example, the terminal device 110 may be any terminal device, which includes but not is limited to a terminal device in wired or wireless connection with the network device 120 or other terminal devices.

In an example, the terminal device 110 may be used for device to device (D2D) communication.

The access network device 121 may include one or a combination of at least two of the following: an evolutional base station in a long term evolution (LTE) system (evolutional node B, eNB or eNodeB), a next generation radio access network (NG RAN) device, a base station in an NR system (gNB), a small station, a micro station, a wireless controller in a cloud radio access network (CRAN), a wireless-fidelity (Wi-Fi) access point, a transmission reception point (TRP), a relay station, an access point, an onboard device, a wearable device, a hub, a switch, a bridge, a router, or a network device in a future evolved public land mobile network (PLMN), etc.

The core network device 122 may be a 5G core (5GC) device, which may include one or a combination of at least two of the following: access and mobility management function (AMF), authentication server function (AUSF), user plane function (UPF), session management function (SMF), or location management function (LMF). In other implementations, the core network device may also be an evolved packet core (EPC) device of the LTE network, for example, a device with session management function+core packet gateway (SMF+PGW-C). It should be understood that SMF+PGW-C may simultaneously achieve the functions that SMF and PGW-C can achieve. In the process of network evolution, the above core network device 122 may also be referred to as other names, or a new network entity may be formed by dividing the functions of the core network, which is not limited by embodiments of the present disclosure.

Functional units in the communication system 100 may also establish connections through a next generation (NG) interface to realize communication.

For example, the terminal device establishes an air interface connection with the access network device through the NR interface for transmitting user plane data and control plane signaling. The terminal device may establish a control plane signaling connection with AMF through an NG interface 1 (N1 for short). The access network device such as a next generation radio access base station (gNB) may establish a user plane data connection with UPF through an NG interface 3 (N3 for short). The access network device may establish a control plane signaling connection with AMF through an NG interface 2 (N2 for short). UPF may establish a control plane signaling connection with SMF through an NG interface 4 (N4 for short). UPF may interact user plane data with data network through an NG interface 6 (N6 for short). AMF may establish a control plane signaling connection with SMF through an NG interface 11 (N11 for short). SMF may establish a control plane signaling connection with PCF through an NG Interface 7 (N7 for short).

FIG. 1 exemplarily illustrates a base station, a core network device and two terminal devices. In an example, the wireless communication system 100 may include multiple base station devices, and the coverage area of each base station may include other numbers of terminal devices, which is not limited by embodiments of the present disclosure.

The non-terrestrial network (NTN) generally provides communication services to ground users by means of satellite communication. Compared with terrestrial cellular network communication, satellite communication has many unique advantages. First of all, the satellite communication is not limited by users' regions. For example, general land communication cannot cover areas such as oceans, mountains, deserts, etc., where communication devices cannot be set up or communication coverage cannot be done due to sparse population. For satellite communication, since one satellite can cover a large area and the satellite can orbit around the earth in orbital motion, theoretically every corner on the earth can be covered by the satellite communication. Secondly, the satellite communication has great social value. The satellite communication can cover remote mountainous areas, poor and underdeveloped countries or regions at a lower cost, so that people in these areas can enjoy advanced voice communication and mobile Internet technology, which is conducive to narrowing the digital divide with developed areas and promoting the development of these areas. Thirdly, the satellite communication distance is long, and the communication cost does not increase significantly with the increase of communication distance. Finally, the satellite communication has high stability and is not limited by natural disasters.

NTN technology can be combined with various communication systems. For example, NTN technology can be combined with the NR system to form an NR-NTN system. For another example, NTN technology can be combined with the internet of things (IoT) system to form an IoT-NTN system. For example, the IoT-NTN system may include an NB-IoT-NTN system and an eMTC-NTN system.

FIG. 2 is a schematic architecture diagram of a communication system provided by an embodiment of the present disclosure. As illustrated in FIG. 2, a communication system 200 of FIG. 2 may be a non-terrestrial network system, which includes a terminal device 201 and a satellite 202. Wireless communication can be performed between the terminal device 201 and the satellite 202. The network formed between the terminal device 201 and the satellite 202 may also be referred to as NTN. In the architecture of the communication system 200 illustrated in FIG. 2, the satellite 202 may have the function of a base station, and direct communication may be performed between the terminal device 201 and the satellite 202. Under the system architecture, the satellite 202 may be referred to as a network device. In some embodiments of the present disclosure, the communication system 200 may include multiple network devices 202, and the coverage area of each network device 202 may include other numbers of terminal devices, which is not limited by embodiments of the present disclosure.

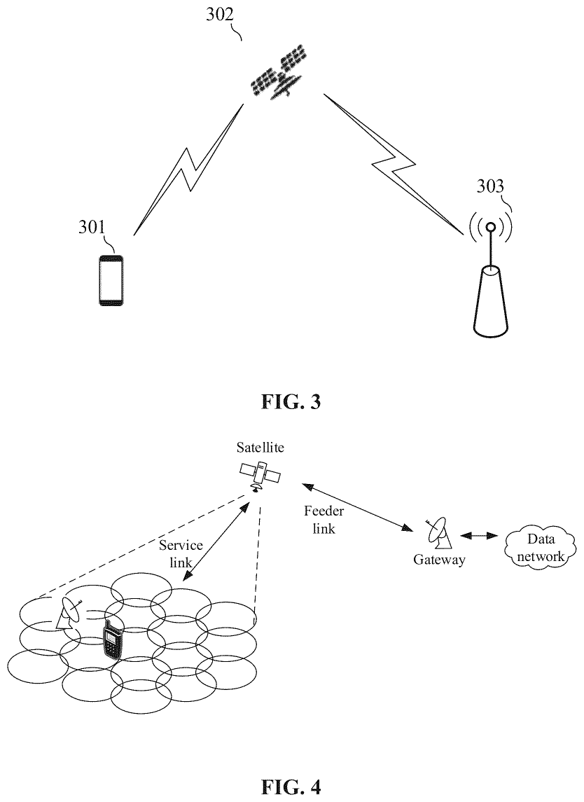

FIG. 3 is a schematic architecture diagram of another communication system provided by an embodiment of the present disclosure. As illustrated in FIG. 3, a communication system 300 of FIG. 3 may be a non-terrestrial network system, which includes a terminal device 301, a satellite 302, and a base station 303. Wireless communication can be performed between the terminal device 301 and the satellite 302, and communication may be performed between the satellite 302 and the base station 303. The network formed among the terminal device 301, the satellite 302, and the base station 303 may also be referred to as NTN. In the architecture of the communication system 300 illustrated in FIG. 3, the satellite 302 may not have the function of a base station, and the communication between the terminal device 301 and the base station 303 needs to be relayed through the satellite 302. Under this system architecture, the base station 303 may be referred to as a network device. In some embodiments of the present disclosure, the communication system may include multiple base stations 303, and the coverage area of each base station 303 may include other numbers of terminal devices, which is not limited by embodiments of the present disclosure. The base station 303 may be the access network device 121 in FIG. 1.

It should be understood that, the above satellite 202 or satellite 302 may include but is not limited to: a low-earth orbit (LEO) satellite, a medium-earth orbit (MEO) satellite, a geostationary earth orbit (GEO) satellite, a high elliptical orbit (HEO) satellite, and the like. Satellites may use multiple beams to cover the ground, for example, a satellite may form dozens or even hundreds of beams to cover the ground. In other words, a satellite beam may cover a ground area with a diameter of dozens to hundreds of kilometers to ensure satellite coverage and enhance the system capacity of the entire satellite communication system.

As an example, the altitude range of LEO satellites may be from 500 kilometers to 1500 kilometers, and the corresponding orbital period may be about 1.5 hours to 2 hours. The signal propagation delay of single hop communication between users is generally less than 20 milliseconds, and the maximum satellite visibility time may be 20 minutes. LEO satellite has a short signal transmission distance and low link loss, and do not require high transmission power from user terminals. The orbit altitude of a GEO satellite may reach 35786 km, and its rotation period around the Earth can be 24 hours. The signal propagation delay of single-hop communication between users may generally be 250 milliseconds.

In order to ensure the coverage of satellites and improve the system capacity of the entire satellite communication system, satellites cover the ground with multiple beams, and one satellite can form dozens or even hundreds of beams to cover the ground. A satellite beam can cover the ground area with a diameter of dozens to hundreds of kilometers.

It should be noted that FIG. 1 to FIG. 3 only illustrate the system to which the present disclosure applies by way of example, and of course the method shown in embodiments of the present disclosure may also be applicable to other systems. In addition, the terms “system” and “network” are often used interchangeably in the present disclosure. The term “and/or” in the present disclosure is only an association relationship describing associated objects and represents that three relationships may exist. For example, A and/or B may represent three conditions: i.e., independent existence of A, existence of both A and B and independent existence of B. In addition, character “/” in the present disclosure usually represents that previous and next associated objects form an “or” relationship. It should also be understood that the reference to “indication” in embodiments of the present disclosure may be a direct indication, may be an indirect indication, or may be indicative of an association. For example, A indicates B, which can mean that A directly indicates B, for example, B can be obtained through A. It can also mean that A indirectly indicates B, for example, A indicates C, and B can be obtained through C. It can also mean that there is an association between A and B. It should also be understood that in embodiments of the present disclosure, “correspond” may mean that there is a direct correspondence or an indirect correspondence between the two, may also mean that there is an association relationship between the two, may also be a relationship between indication and being indicated, configuration and being configured, etc. It should also be understood that in embodiments of the present disclosure, “predefined”, “protocol specified”, “pre-determined” or “predefined rules” may be achieved by pre-storing corresponding codes, tables or other means that may be used to indicate relevant information in devices (e.g., including terminal devices and network devices), and the present disclosure does not limit the specific implementation thereof. For example, predefined may refer to being defined in the protocol. It should also be understood that in embodiments of the present disclosure, “protocol” may refer to standard protocols in the communication field, for example, may include LTE protocol, NR protocol and related protocols applied in future communication systems, which are not limited in the present disclosure.

Satellites may be divided into two types based on their provided functions: transparent payload satellites and regenerative payload satellites. Transparent payload satellites may provide wireless frequency filtering function, and frequency conversion and amplification functions, and may provide transparent forwarding of signals without changing the waveform signals forwarded. Regenerative payload satellites, in addition to providing wireless frequency function, and frequency conversion and amplification functions, may also provide demodulation/decoding, routing/conversion, encoding/modulation functions, which have some or all of the functions of a base station.

In NTN, one or more gateways may be included for communication between satellites and terminals.

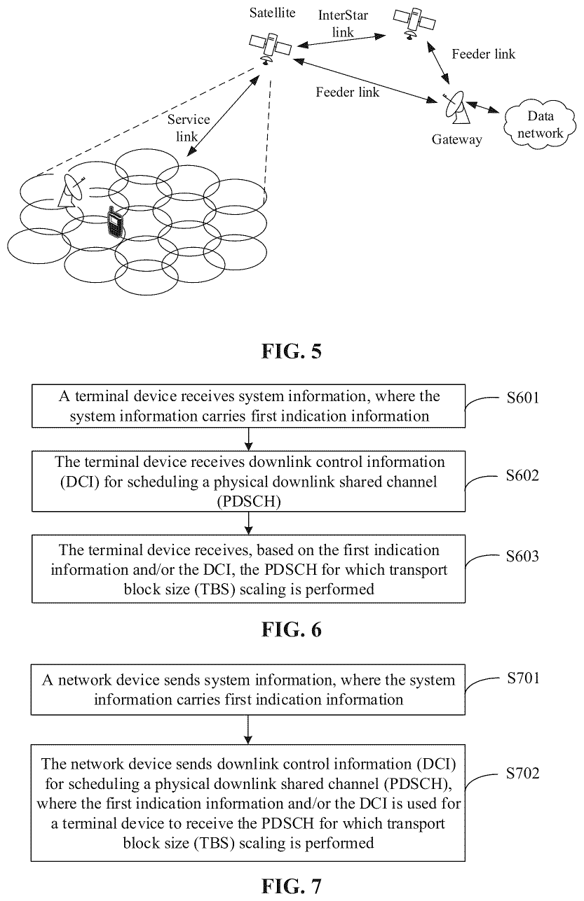

FIG. 4 is a schematic diagram of an NTN scenario based on a transparent payload satellite provided by an embodiment of the present disclosure, and FIG. 5 is a schematic diagram of an NTN scenario based on regenerative payload satellites provided by an embodiment of the present disclosure.

As illustrated in FIG. 4, for the NTN scenario based on a transparent payload satellite, the gateway and satellite communicate through a feeder link, and the satellite and terminal may communicate through a service link. As illustrated in FIG. 5, for the NTN scenario based on regenerative payload satellites, satellites communicate through an InterStar link, the gateway and satellite communicate through a feeder link, and the satellite and terminal may communicate through a service link.

In order to facilitate understanding of the technical solutions of embodiments of the present disclosure, the following related technologies of embodiments of the present disclosure are described. As an exemplary solution, the following related technologies may be arbitrarily combined with the technical solution of embodiments of the present disclosure, and all of them belong to the protection scope of embodiments of the present disclosure.

For a physical downlink shared channel (PDSCH) scheduled by DCI 1_0, DCI 1_1, or DCI 1_2 with cyclic redundancy check (CRC) scrambled by a cell-radio network temporary identifier (C-RNTI), a modulation coding scheme-cell-radio network temporary identifier (MCS-C-RNTI), a temporary cell-radio network temporary identifier (TC-RNTI), a configured scheduling-radio network temporary identifier (CS-RNTI) or a system information-radio network temporary identifier (SI-RNTI), the terminal device may determine the transport block size (TBS) according to the following regulations:
(1) The number of REs N_{RE} within a slot is determined.

Firstly, formula N′_{RE}=N_{sc}^{RB}·N_{symb}^{sh}−N_{DMRS}^{PRB}−Nₒₕ^{PRB} is used to determine the number of resource elements (REs) used for PDSCH transmission in a physical resource block (PRB). Here N_{sc}^{RB}=12 is the number of subcarriers in a PRB, N_{symb}^{sh} is the number of symbols allocated for the PDSCH in a slot, N_{DMRS}^{PRB} is the number of REs of a demodulation reference signal (DMRS) on each PRB during scheduling time, and Nₒₕ^{PRB} is the signaling overhead configured by high-level parameters.

Then, formula N_{RE}=min(156, N′_{RE})·n_{PRB} is used to determine the total number of RES (N_{RE}) used for PDSCH transmission. Here n_{PRB} is the total number of PRBs allocated for the terminal device.
(2) Formula N_{info}=N_{RE}·R·Qₘ·v is used to obtain the unquantized intermediate variable N_{info}. Here R is the target bit rate, Qₘ is the modulation order, and v is the transmission layer number.
(3) Finally, N_{info} is quantized to determine the transport block size (TBS).

For the PDSCH scheduled by DCI 1_0 with CRC scrambled by a paging-radio network temporary identifier (P-RNTI), a random access-radio network temporary identifier (RA-RNTI), or a MsgB-radio network temporary identifier (MsgB-RNTI), operation (2) is modified when determining TBS, and scaling N_{info}=S·N_{RE}·R·Qₘ·v is applied to the calculation process of N_{info}. Here the scaling factor S is determined based on an indication of a transport block scaling (TB scaling) domain in DCI 1_0.

After applying TBS scaling, TBS is effectively reduced in the case of the total number of time-frequency resources used for PDSCH transmission unchanged, thereby improving coverage performance.

However, the relevant technical solutions support to perform TBS scaling for a PDSCH scheduled by DCI 1_0 with CRC scrambled by P-RNTI, RA-RNTI, or MsgB-RNTI, and TBS is scaled up to ¼ of its original size, which has limited improvement on system coverage performance. In addition, for communication scenarios with limited coverage performance, such as the NTN system, the currently supported TBS scaling factors may not meet the coverage requirements. In addition, the PDSCH scheduled by DCI 1_0 with CRC scrambled by other RNTIs does not support TBS scaling solutions, such as Msg4 PDSCH. Therefore, it is necessary to enhance the TBS scaling solutions of existing PDSCHs to improve coverage performance.

In order to facilitate understanding of the technical solutions of embodiments of the present disclosure, the technical solutions of the present disclosure will be described in detail below by way of specific embodiments. As an optional solution, the above related technology may be arbitrarily combined with the technical solutions of embodiments of the present disclosure, and all of them belong to the protection scope of embodiments of the present disclosure. Embodiments of the present disclosure include at least some of the following.

FIG. 6 is a schematic flowchart of a communication method provided by an embodiment of the present disclosure. As illustrated in FIG. 6, the method includes the following operations.

At S601, a terminal device receives system information (SI). Herein the system information carries first indication information.

At S602, the terminal device receives downlink control information (DCI) for scheduling a physical downlink shared channel (PDSCH).

At S603, the terminal device receives, based on the first indication information and/or the DCI, the PDSCH for which transport block size (TBS) scaling is performed.

In other embodiments of the present disclosure, S601 may be replaced by the operation: a terminal device receives a broadcast message. Herein the broadcast message carries first indication information.

In still other embodiments of the present disclosure, S601 may be replaced by the operation: a terminal device receives first indication information. In this case, the first indication information may be a broadcast message, a multicast message, or a unicast message. For example, the first indication information may be the indication information sent by a network device to the terminal device when the terminal device is connected to the network device.

FIG. 7 is a schematic flowchart of another communication method provided by an embodiment of the present disclosure. As illustrated in FIG. 7, the method includes the following operations.

At S701, a network device sends system information. Herein the system information carries first indication information.

At S702, the network device sends downlink control information (DCI) for scheduling a physical downlink shared channel (PDSCH). Here, the first indication information and/or the DCI are used for a terminal device to receive the PDSCH for which transport block size (TBS) scaling is performed.

In other embodiments of the present disclosure, S701 may be replaced by the operation: a network device sends a broadcast message. Herein the broadcast message carries first indication information.

In still other embodiments of the present disclosure, S701 may be replaced by the operation: a network device sends first indication information. In this case, the first indication information may be a broadcast message, a multicast message, or a unicast message. For example, the first indication information may be the indication information sent by a network device to the terminal device when the terminal device is connected to the network device.

In some embodiments, the master information block (MIB) or system information block (SIB) in the system information carries the first indication information.

In an example, the network device may transmit, based on the first indication information and/or the DCI, the PDSCH for which TBS scaling is performed. In an example, the network device may perform TBS scaling for the PDSCH based on the first indication information and/or the DCI, and send the PDSCH for which TBS scaling has been performed.

In an example, the operation of the terminal device receiving the system information may include that: the terminal device receives the system information sent by the network device. In an example, the operation of the network device sending the system information may include that: the network device sends/broadcasts the system information to the terminal device.

In an example, the first indication information may be explicit indication information or implicit indication information. In the case that the first indication information is explicit indication information, the first indication information includes one or more bits, which may be continuous or discontinuous or at least partially continuous, and the one or more bits are used to indicate information. In the case that the first indication information is implicit indication information, the first indication information corresponds to the target domain or target field in the system information, which is used to configure information related to the first indication information.

In an example, the first indication information may be the indication information in the protocol prior to the present disclosure, or the first indication information may be the indication information specified in the protocol after the present disclosure. In an example, one or more reserved bits in the protocol prior to the present disclosure may be set as a target value, and the first indication information may be the target value.

In an example, the terminal device may receive, based on the first indication information, the PDSCH for which TBS scaling is performed. In an example, the terminal device may receive, based on the DCI, the PDSCH for which TBS scaling is performed. In an example, the terminal device may receive, based on the first indication information and the DCI, the PDSCH for which TBS scaling is performed.

In an example, the PDSCH for which TBS scaling is performed in any embodiment of the present disclosure may be understood in the same way as the PDSCH after TBS scaling. In an example, the terminal device receiving the PDSCH for which TBS scaling is performed may include that: the terminal device determines the scaled TBS, and receives, based on the scaled TBS, the PDSCH for which TBS scaling is performed.

In an example, the method of the terminal device determining the scaled TBS may be determined through operations (1) to (3) above.

In an example, the terminal device may receive, based on one of one or more TBS scaling factors indicated by the first indication information, the PDSCH for which TBS scaling is performed. In an example, the terminal device may receive, based on one of the one or more TBS scaling factors indicated by the DCI, the PDSCH for which TBS scaling is performed. In an example, the terminal device may receive, based on one of the one or more TBS scaling factors indicated by the first indication information and one of the one or more TBS scaling factors indicated by the DCI, the PDSCH for which TBS scaling is performed.

In an example, in the case that the first indication information does not indicate the one or more TBS scaling factors for the PDSCH, or in the case that the one or more TBS scaling factors for the PDSCH indicated by the first indication information do not meet the requirements, or in the case that the one or more TBS scaling factors for the PDSCH indicated by a first TB scaling domain included in the DCI do not meet the requirements, or in the case that the first TB scaling domain included in the DCI indicates an invalid value, or in the case that the DCI does not include the first TB scaling domain, the terminal device may receive, based on a target scaling factor specified in the protocol, or a pre-configured target scaling factor, or a default target scaling factor, the PDSCH for which TBS scaling is performed. In an example, furthermore, if the DCI indicates a second scaling factor, then the terminal device may receive, based on the target scaling factor and the second scaling factor indicated by the DCI, the PDSCH for which TBS scaling is performed. In an example, the target scaling factor may be the fourth scaling factor or the eighth scaling factor as described below.

In an embodiment of the present disclosure, the terminal device receives the system information. Herein the system information carries the first indication information. The terminal device receives the downlink control information (DCI) for scheduling the physical downlink shared channel (PDSCH). The terminal device receives, based on the first indication information and/or the DCI, the PDSCH for which transport block size (TBS) scaling is performed. In this way, based on the first indication information and/or the DCI, the terminal device may receive the PDSCH for which transport block size (TBS) scaling is performed, so as to accurately receive the PDSCH for which TBS scaling is performed.

In some embodiments, the first indication information indicates one or more TBS scaling factors for the PDSCH. In other embodiments, the first indication information does not indicate one or more TBS scaling factors for the PDSCH.

In an example, the first indication information may indicate a TBS scaling factor for the PDSCH. In an example, the first indication information may indicate multiple TBS scaling factors for the PDSCH. Exemplary, the first indication information may carry a TBS scaling factor, or the first indication information may carry multiple TBS scaling factors. Exemplary, the first indication information may indicate one TBS scaling factor in a TBS scaling factor set specified in the protocol/pre-configured by the terminal device, or the first indication information may indicate multiple TBS scaling factors in a TBS scaling factor set specified in the protocol/pre-configured by the terminal device. In an example, the TBS scaling factor set may include at least one TBS scaling factor. The TBS scaling factor set may be the set specified in the protocol prior to the present disclosure (i.e., an existing protocol), or may be the set specified in the protocol after the present disclosure (i.e., a protocol after the present disclosure). The TBS scaling factors in the set specified in the protocol prior to the present disclosure are at least partially different from the TBS scaling factors in the set specified in the protocol after the present disclosure.

In any embodiment of the present disclosure, the TBS scaling factor may also be referred to as: a scaling factor, a scaling factor of TBS, or a scaling factor corresponding to TBS.

In an example, each of one or more TBS scaling factors may be used for TBS scaling for the PDSCH.

In an example, the one or more TBS scaling factors indicated by the first indication information may be TBS scaling factors in the NTN system. In an example, the one or more TBS scaling factors indicated by the first indication information may be TBS scaling factors in the NR system.

In an example, the one or more TBS scaling factors indicated by the first indication information may be specified in the existing protocol (i.e., the protocol prior to the present disclosure), or may be specified in the future protocol (i.e., the protocol after the present disclosure), or may be configured by the network device, or may be pre-configured by the terminal device.

In an example, the terminal device/network device may use or not use one of the one or more TBS scaling factors indicated by the first indication information based on a measured value of a reference signal and/or whether the terminal device has a capability to receive a PDSCH for which TBS scaling is performed. In an example, when in use, the terminal device/network device may also determine to use which one of one or more TBS scaling factors based on the measured value of the reference signal and/or whether the terminal device has the capability to receive the PDSCH for which TBS scaling is performed. For example, in the case that the measured value of the reference signal is greater than a first threshold (representing high channel quality), and/or in the case that the terminal device does not have the capability to receive the PDSCH for which TBS scaling is performed, or the terminal device does not have the capability to use the one or more TBS scaling factors indicated by the first indication information, the terminal device may not use any one of the one or more TBS scaling factors indicated by the first indication information. Furthermore, in an example, the terminal device may use TBS scaling factors in the existing protocol indicated by the DCI for scheduling the PDSCH. For another example, in the case that the measured value of the reference signal is less than or equal to the first threshold (representing low channel quality), and in the case that the terminal device has the capability to receive the PDSCH for which TBS scaling is performed, or the terminal device has the capability to use the one or more TBS scaling factors indicated by the first indication information, the terminal device may use one of the one or more TBS scaling factors indicated by the first indication information. Furthermore, in an example, the terminal device may also jointly use or not use TBS scaling factors in the existing protocol indicated by the DCI for scheduling the PDSCH. In an example, in the case of higher channel quality, the scaling factor for the PDSCH for which TBS scaling is performed may be greater, and/or in the case of lower channel quality, the scaling factor for the PDSCH for which TBS scaling is performed may be smaller.

In an example, in any embodiment of the present disclosure, the terminal device using a TBS scaling factor may include that: the terminal device determines the scaled TBS based on the TBS scaling factor. In an example, this operation may further include that: the PDSCH for which TBS scaling is performed is received based on the scaled TBS.

In an example, in the case that the terminal device does not use a certain one of the one or more TBS scaling factors indicated by the first indication information, the terminal device may use a certain one of one or more TBS scaling factors indicated by other information, or, the terminal device may use a certain one of one or more TBS scaling factors specified in the protocol or pre-configured. In an example, other information may be sent from the network devices to the terminal device. In an example, other information and the first indication information are carried through different signaling. In an example, other information may be unicast information, broadcast information, or multicast information. In an example, other information may be DCI used for scheduling the PDSCH.

In an example, the first indication information being not used to indicate the one or more TBS scaling factors for the PDSCH may include that: the first indication information does not carry the one or more TBS scaling factors; or the first indication information does not indicate a TBS scaling factor in a TBS scaling factor set specified in the protocol/pre-configured by the terminal device; or the first indication information does not indicate multiple TBS scaling factors in the TBS scaling factor set specified in the protocol/pre-configured by the terminal device.

In an example, the first indication information may be any indication information in the system information. In an example, the first indication information may be the indication information in the existing protocol or the indication information in the protocol after the present disclosure.

In an example, the first indication information does not indicate one or more TBS scaling factors for the PDSCH, which may be understood as: the system information does not carry information for indicating one or more TBS scaling factors for the PDSCH.

In some embodiments, the DCI includes a first TB scaling domain. Here the first TB scaling domain indicates one or more TBS scaling factors for the PDSCH.

In other embodiments, the DCI includes the first TB scaling domain. Herein the first TB scaling domain indicates an invalid value, and the invalid value is an invalid TBS scaling factor or is null. In an example, the invalid TBS scaling factor may represent that the scaling factor cannot perform TBS scaling. For example, the invalid TBS scaling factor may be −1, 2, or other values.

In other embodiments, the DCI does not include a first TB scaling domain.

In some embodiments, the terminal device receiving, based on the first indication information and/or the DCI, the PDSCH for which transport block size (TBS) scaling is performed includes the following actions.

The terminal device sends second indication information based on at least one of: the first indication information, a measured value of a reference signal, or the terminal device having a capability to receive a PDSCH for which TBS scaling is performed. The second indication information is used to request transport block size (TBS) scaling for a physical downlink shared channel (PDSCH), or to request a new TBS scaling factor.

The terminal device receives third indication information.

The terminal device receives, based on the third indication information and/or the DCI, the PDSCH for which TBS scaling is performed.

In this way, for the network device side, the network device receives second indication information. The second indication information is used to request transport block size (TBS) scaling for the physical downlink shared channel (PDSCH), or to request a new TBS scaling factor.

The network device sends third indication information.

Herein the third indication information and/or the DCI are used for the terminal device to receive the PDSCH for which transport block size (TBS) scaling is performed.

In other embodiments, the terminal device receiving, based on the first indication information and/or the DCI, the PDSCH for which transport block size (TBS) scaling is performed includes the following actions. The terminal device sends the second indication information based on at least one of: the first indication information, the measured value of the reference signal, or the terminal device having the capability to receive PDSCH for which TBS scaling is performed.

Here, the second indication information corresponds to one or more TBS scaling factors for the PDSCH indicated by the first indication information; and/or,

the second indication information corresponds to one or more TBS scaling factors for the PDSCH specified in the protocol or pre-configured; and/or,

the second indication information corresponds to one or more TBS scaling factors for the PDSCH indicated by the DCI.

In this case, the terminal device may receive, based on the scaling factor(s) corresponding to the second indication information, the PDSCH for which TBS scaling is performed. In an example, if the second indication information corresponds to the one or more TBS scaling factors for the PDSCH indicated by the first indication information, then the terminal device may receive, based on one of the one or more TBS scaling factors for the PDSCH indicated by the first indication information, the PDSCH for which TBS scaling is performed. In another example, if the second indication information corresponds to the one or more TBS scaling factors for the PDSCH indicated by the first indication information, and corresponds to the one or more TBS scaling factors for the PDSCH indicated by the DCI, then the terminal device may receive the PDSCH for which TBS scaling is performed, based on one of the one or more TBS scaling factors for the PDSCH indicated by the first indication information and one of the one or more TBS scaling factors for the PDSCH indicated by the DCI.

In an example, the one or more TBS scaling factors specified in the protocol or pre-configured may include the fourth scaling factor described below, or may include the second set including one or more scaling factors described below.

In an example, in the case that the second indication information corresponds to the one or more TBS scaling factors for the PDSCH indicated by the first indication information, the terminal device indicates to the network device through the second indication information that one of the one or more TBS scaling factors for the PDSCH indicated by the first indication information is used; or, the terminal device indicates to the network device through the second indication information that the PDSCH for which TBS scaling is performed is received based on one of the one or more TBS scaling factors for the PDSCH indicated by the first indication information.

In an example, in the case that the second indication information corresponds to the one or more TBS scaling factors for the PDSCH specified in the protocol or pre-configured, the terminal device indicates to the network device through the second indication information that one of the one or more TBS scaling factors for the PDSCH specified in the protocol or pre-configured is used; or, the terminal device indicates to the network device through the second indication information that: the PDSCH for which TBS scaling is performed is received based on one of the one or more TBS scaling factors for the PDSCH specified in the protocol or pre-configured.

In the case that the second indication information corresponds to the one or more TBS scaling factors for the PDSCH indicated by the DCI, the terminal device indicates to the network device through the second indication information that one of the one or more TBS scaling factors for the PDSCH indicated by the DCI is used; or, the terminal device indicates to the network device through the second indication information: the PDSCH for which TBS scaling is performed is received based on one of the one or more TBS scaling factors for the PDSCH indicated by the DCI.

In an example, the operation of the terminal device sending the second indication information based on the first indication information may include: in the case that the first indication information does not indicate the one or more TBS scaling factors for the PDSCH, the terminal device sends the second indication information. In an example, the terminal device sending the second indication information based on the first indication information may include: in the case that the first indication information indicates the one or more TBS scaling factors for the PDSCH, and the terminal device cannot use a certain one or any one of the one or more TBS scaling factors, the terminal device sends the second indication information. In an example, the terminal device sending the second indication information based on the first indication information may include: in the case that the first indication information indicates the one or more TBS scaling factors for the PDSCH, and the one or more TBS scaling factors do not meet the requirements or do not include a preset TBS scaling factor, the terminal device sends the second indication information.

In an example, the operation of the terminal device sending the second indication information based on the measured value of the reference signal may include that: in the case that the measured value of the reference signal is less than or equal to a threshold, the terminal device sends the second indication information.

In an example, if the terminal device has the capability to receive the PDSCH for which TBS scaling is performed, then the terminal device sends the second indication information. In other embodiments, if the terminal device does not have the capability to receive the PDSCH for which TBS scaling is performed, then the terminal device does not send the second indication information.

In an example, in some embodiments, the terminal device sending the second indication information includes that: in the case that the communication of the terminal device is NTN communication, the terminal device sends the second indication information. For example, in the case that the communication of the terminal device is NTN communication, the terminal device sends the second indication information based on at least one of: the first indication information, the measured value of the reference signal being less than or equal to the threshold, or the terminal device having the capability to receive the PDSCH for which TBS scaling is performed.

In an example, the reference signal may be sent from the network device to the terminal device. Exemplary, the reference signal may include at least one of the following: a synchronization signal block (SSB), or a channel state information-reference signal (CSI-RS). Here, SSB may also be referred to as a synchronization signal/physical broadcast channel block (SS/PBCH block).

In an example, the measured value may include at least one of the following measurement parameter values: reference signal received power (RSRP), reference signal received quality (RSRQ), received signal strength indicator (RSSI), or signal to interference and noise ratio (SINR).

In an example, the thresholds corresponding to different measurement parameter values may be the same or different. In an example, the thresholds corresponding to different reference signals may be the same or different.

In an example, if the measured value of the reference signal is less than or equal to the threshold, it can indicate that the terminal device determines that the communication quality is poor in the current coverage situation. The TBS scaling factors indicated by the DCI for scheduling the PDSCH prior to the present disclosure will result in a high bit error rate, and the reliability of the terminal device receiving downlink information will decrease. The terminal device may send the second indication information to the network device, so that the network device may send third indication information to the terminal device, to indicate the one or more TBS scaling factors through the third indication information. The one or more TBS scaling factors are TBS scaling factors specified in the protocol after the present disclosure. The one or more TBS scaling factors are different from the TBS scaling factors prior to the present disclosure, so that the terminal device may use the bit error rate corresponding to the current communication quality as needed.

In an example, the terminal device may report the measurement value of the reference signal to the network device, so that the network device may indicate the TBS scaling factor corresponding to the measurement value of the reference signal to the terminal device. In an example, the terminal device may report the communication quality level corresponding to the measurement value of the reference signal to the network device, so that the network device may indicate the TBS scaling factor corresponding to the communication quality level to the terminal device. In an example, in the case that the terminal device has the capability to receive the PDSCH for which TBS scaling is performed, the terminal device may receive the PDSCH for which transport block size (TBS) scaling is performed.

In an example, the third indication information may be included in a message during the random access process. For example, the third indication information may be included in the random access response (RAR) or msg2. For another example, the third indication information may be included in the msg4 or the msgB.

In an example, the third indication information may be included in a radio resource control (RRC) message, downlink control information (DCI), or a medium access control control element (MAC CE).

In an example, the third indication information may indicate one or more TBS scaling factors for the PDSCH; or, the third indication information may not indicate one or more TBS scaling factors for the PDSCH.

In an example, the terminal device may receive, based on one of the one or more TBS scaling factors indicated by the third indication information, the PDSCH for which TBS scaling is performed. In an example, the terminal device may receive, based on one of the one or more TBS scaling factors indicated by the DCI, the PDSCH for which TBS scaling is performed. In an example, the terminal device may receive, based on one of the one or more TBS scaling factors indicated by the third indication information and one of the one or more TBS scaling factors indicated by the DCI, the PDSCH for which TBS scaling is performed.

In an example, in the case that the third indication information does not indicate the one or more TBS scaling factors for the PDSCH, or in the case that the one or more TBS scaling factors for the PDSCH indicated by the third indication information do not meet the requirements, or in the case that the one or more TBS scaling factors for the PDSCH indicated by a first TB scaling domain in the DCI do not meet the requirements, or in the case that the first TB scaling domain in the DCI indicates an invalid value, or in the case that the DCI does not include the first TB scaling domain, the terminal device may receive the PDSCH for which TBS scaling is performed based on a target scaling factor specified in the protocol, or a pre-configured target scaling factor, or a default target scaling factor. In an example, furthermore, if the DCI indicates a second scaling factor, then the terminal device may receive, based on the target scaling factor and the second scaling factor indicated by the DCI, the PDSCH for which TBS scaling is performed. In an example, the target scaling factor may be the fourth scaling factor or the eighth scaling factor as described below.

In some embodiments, the operation of the terminal device receiving, based on the first indication information, the PDSCH for which TBS scaling is performed includes that: the terminal device receives, based on a first scaling factor indicated by the first indication information or the third indication information, the PDSCH for which TBS scaling is performed.

In this way, for the network device side, the first indication information or the third indication information indicates the first scaling factor; and the first scaling factor is used for the terminal device to receive the PDSCH for which TBS scaling is performed.

In an example, the first indication information or the third indication information may include a first TBS scaling factor. In an example, the first indication information or the third indication information may include a target domain or one or more bits, and the target domain or one or more bits indicate the first TBS scaling factor among the one or more TBS scaling factors. In an example, the one or more TBS scaling factors that include the first TBS scaling factor indicated by the first indication information or the third indication information may be at least one of the following: one or more TBS scaling factors specified in the protocol prior to the present disclosure, one or more TBS scaling factors specified in the protocol after the present disclosure, one or more TBS scaling factors included in the first indication information or the third indication information, or one or more TBS scaling factors pre-configured by the terminal device.

In some embodiments, the operation of the terminal device receiving, based on the DCI, the PDSCH for which TBS scaling is performed includes that: the terminal device receives, based on a second scaling factor indicated by the DCI, the PDSCH for which TBS scaling is performed.

In this way, for the network device side, the DCI indicates the second scaling factor; and the second scaling factor is used for the terminal device to receive the PDSCH for which TBS scaling is performed.

In an example, the DCI may include at least one of the following: a first TB scaling domain, an MCS domain, a reserved bit(s), or a second TB scaling domain. Here, the second scaling factor indicated by the DCI may be the second scaling factor indicated by at least one of the following in DCI: a first TB scaling domain, an MCS domain, a reserved bit(s), or a second TB scaling domain.

In an example, the one or more TBS scaling factors that include the second scaling factor indicated by the DCI may be at least one of the following: one or more TBS scaling factors specified in the protocol prior to the present disclosure, one or more TBS scaling factors specified in the protocol after the present disclosure, one or more TBS scaling factors included in the first indication information or the third indication information, or one or more TBS scaling factors pre-configured by the terminal device.

In some embodiments, the operation of the terminal device receiving, based on the first indication information and/or the DCI, the PDSCH for which TBS scaling is performed includes that: the terminal device receives, based on the first scaling factor indicated by the first indication information or the third indication information and the second scaling factor indicated by the DCI, the PDSCH for which TBS scaling is performed.

In this way, for the network device side, the first indication information or the third indication information indicates the first scaling factor, the DCI carries the second scaling factor; and the first scaling factor and the second scaling factor are used for the terminal device to receive the PDSCH for which TBS scaling is performed.

In an example, the second TBS scaling factor may be indicated by the first TB scaling domain in the DCI for scheduling the PDSCH. In an example, the second TBS scaling factor may be indicated by another indication domain in the DCI for scheduling the PDSCH. In an example, the second scaling factor may be included in at least one of the following: one or more TBS scaling factors specified in the protocol prior to the present disclosure, one or more TBS scaling factors specified in the protocol after the present disclosure, one or more TBS scaling factors indicated by the first indication information or the third indication information, or one or more TBS scaling factors pre-configured by the terminal device. For example, the second TBS scaling factor may be included in one or more TBS scaling factors specified in the protocol prior to the present disclosure.

The another indication domain in any embodiment of the present disclosure may be: another existing indication domain or an indication domain newly added/defined using reserved bit(s). For example, the another existing indication domain may be the MCS domain described below, or the another existing indication domain may be one or more reserved bits described below. In an example, a newly added/defined indication domain may be defined using the one or more reserved bits. In an example, the newly added/defined indication domain may be the second TB scaling domain described below.

In an example, the third TBS scaling factor may be less than the first TBS scaling factor; or, the third TBS scaling factor may be greater than the first TBS scaling factor. In an example, the third TBS scaling factor may be less than the second TBS scaling factor; or, the third TBS scaling factor may be greater than the second TBS scaling factor.

In some embodiments, the operation of the terminal device receiving, based on the first scaling factor indicated by the first indication information or the third indication information and the second scaling factor indicated by the DCI, the PDSCH for which TBS scaling is performed includes that: the terminal device determines a third scaling factor based on a product of the first scaling factor indicated by the first indication information or the third indication information and the second scaling factor indicated by the DCI; and the terminal device receives, based on the third scaling factor, the PDSCH for which TBS scaling is performed.

In this way, the third TBS scaling factor is determined based on the product of the first TBS scaling factor and the second TBS scaling factor. For example, the third TBS scaling factor is the product of the first TBS scaling factor and the second TBS scaling factor. Other modes for determining the third TBS scaling factor are described below: in other embodiments, the third TBS scaling factor is determined based on the sum of the first TBS scaling factor and the second TBS scaling factor. For example, the third TBS scaling factor is the sum of the first TBS scaling factor and the second TBS scaling factor. In other embodiments, the third TBS scaling factor is determined based on the absolute value of the difference between the first TBS scaling factor and the second TBS scaling factor. For example, the third TBS scaling factor is the absolute value of the difference between the first TBS scaling factor and the second TBS scaling factor. In still other embodiments, the third TBS scaling factor is determined based on the result of dividing the smaller TBS scaling factor by the greater TBS scaling factor among the first TBS scaling factor and the second TBS scaling factor. For example, the third TBS scaling factor is the result of dividing the smaller TBS scaling factor by the greater TBS scaling factor among the first TBS scaling factor and the second TBS scaling factor. In still other embodiments, the third TBS scaling factor is the greater TBS scaling factor among the first TBS scaling factor and the second TBS scaling factor. In still other embodiments, the third TBS scaling factor is the smaller TBS scaling factor among the first TBS scaling factor and the second TBS scaling factor.

In some embodiments, the operation of the terminal device receiving the PDSCH for which TBS scaling is performed includes that: the terminal device receives, based on a fourth scaling factor, the PDSCH for which TBS scaling is performed. Here the fourth scaling factor is a positive number with a value range greater than 0 and less than or equal to 1.

In this way, for the network device side, the first indication information and/or the DCI is used for the terminal device to receive, based on the fourth scaling factor, the PDSCH for which TBS scaling is performed. Here the fourth scaling factor is a positive number with a value range greater than 0 and less than or equal to 1.

In an example, in the case that the TBS scaling factor indicated by the first indication information and/or the DCI does not meet the requirements, or in the case that the first indication information does not indicate one or more TBS scaling factors, or in the case that the first TB scaling domain included in the DCI indicates an invalid value, or in the case that the DCI does not include the first TB scaling domain, the terminal device receives, based on the fourth scaling factor, the PDSCH for which TBS scaling is performed.

In an example, the fourth TBS scaling factor is specified in the protocol, or the fourth TBS scaling factor is determined by the terminal device according to pre configuration, or the fourth TBS scaling factor is a default value.

In an example, in the case that the first indication information or the third indication information does not indicate the one or more TBS scaling factors for the PDSCH, regardless of whether the DCI for scheduling the PDSCH can indicate the second TBS scaling factor, the terminal device receives, based on the fourth scaling factor, the PDSCH for which TBS scaling is performed.

In an example, the value of the fourth TBS scaling factor may be the same or different from the value of the first TBS scaling factor. In an example, the value of the fourth TBS scaling factor may be different or the same as the value of the second TBS scaling factor.

In some embodiments, the operation of the terminal device receiving, based on the fourth scaling factor, the PDSCH for which TBS scaling is performed includes the following actions.

The terminal device determines a fifth scaling factor based on the fourth scaling factor and the second scaling factor indicated by the DCI.

The terminal device receives, based on the fifth scaling factor, the PDSCH for which TBS scaling is performed.

In this way, for the network device side, the first indication information and/or the DCI is used for the terminal device to receive, based on the fourth scaling factor and the second scaling factor indicated by the DCI, the PDSCH for which TBS scaling is performed.

In an example, in the case that the TBS scaling factor indicated by the first indication information and/or the DCI does not meet the requirements, or in the case that the first indication information does not indicate one or more TBS scaling factors, or in the case that the first TB scaling domain included in the DCI indicates an invalid value, or in the case that the DCI does not include the first TB scaling domain, the terminal device receives, based on the fifth scaling factor, the PDSCH for which TBS scaling is performed.

In an example, in the case that the first indication information or the third indication information does not indicate the one or more TBS scaling factors for the PDSCH, regardless of whether the DCI for scheduling the PDSCH can indicate the second TBS scaling factor, the terminal device receives, based on the fifth scaling factor, the PDSCH for which TBS scaling is performed.

In an example, the fifth TBS scaling factor may be less than the fourth TBS scaling factor; or, the fifth TBS scaling factor may be greater than the fourth TBS scaling factor. In an example, the fifth TBS scaling factor may be less than the second TBS scaling factor; or, the fifth TBS scaling factor may be greater than the second TBS scaling factor.

In some embodiments, the operation of the terminal device determining the fifth scaling factor based on the fourth scaling factor and the second scaling factor indicated by the DCI includes that: the terminal device determines the fifth scaling factor based on a product of the fourth scaling factor and the second scaling factor indicated by the DCI.

In this way, the fifth TBS scaling factor is determined based on the product of the fourth TBS scaling factor and the second TBS scaling factor. For example, the fifth TBS scaling factor is the product of the fourth TBS scaling factor and the second TBS scaling factor. Other modes for determining the fifth TBS scaling factor are described below: in other embodiments, the fifth TBS scaling factor is determined based on the sum of the fourth TBS scaling factor and the second TBS scaling factor. For example, the fifth TBS scaling factor is the sum of the fourth TBS scaling factor and the second TBS scaling factor. In other embodiments, the fifth TBS scaling factor is determined based on the absolute value of the difference between the fourth TBS scaling factor and the second TBS scaling factor. For example, the fifth TBS scaling factor is the absolute value of the difference between the fourth TBS scaling factor and the second TBS scaling factor. In still other embodiments, the fifth TBS scaling factor is determined based on the result of dividing the smaller TBS scaling factor by the greater TBS scaling factor among the fourth TBS scaling factor and the second TBS scaling factor. For example, the fifth TBS scaling factor is the result of dividing the smaller TBS scaling factor by the greater TBS scaling factor among the fourth TBS scaling factor and the second TBS scaling factor. In still other embodiments, the fifth TBS scaling factor is the greater TBS scaling factor among the fourth TBS scaling factor and the second TBS scaling factor. In still other embodiments, the fifth TBS scaling factor is the smaller TBS scaling factor among the fourth TBS scaling factor and the second TBS scaling factor.

In some embodiments, the operation of the terminal device receiving, based on the first indication information, the PDSCH for which TBS scaling is performed includes the following actions.

The terminal device determines a sixth scaling factor based on a first set including one or more scaling factors indicated by the first indication information or the third indication information.

The terminal device receives, based on the sixth scaling factor, the PDSCH for which TBS scaling is performed.

In this way, for the network device side, the first indication information or the third indication information indicates the first set including one or more scaling factors; and the first set is used for the terminal device to determine the sixth scaling factor and receive, based on the sixth scaling factor, the PDSCH for which TBS scaling is performed.

In this case, the sixth TBS scaling factor used by the terminal device to receive the PDSCH for which TBS scaling is performed is determined based on one or more TBS scaling factors in the first set indicated by the network device through the first indication information or the third indication information.

In an example, the first set may include a TBS scaling factor, or the first set may include multiple TBS scaling factors. In an example, in some embodiments, the first indication information may include multiple TBS scaling factors in the first set, for example, the first indication information may include TBS scaling factors of 1, 0.5, and 0.125, etc. In an example, in other embodiments, the first set may include indication information for one or more TBS scaling factors in the first set, so that the terminal device may determine the corresponding one or more TBS scaling factors based on the indication information for one or more TBS scaling factors. For example, the protocol may specify at least one TBS scaling factor, or the terminal device may pre-configure at least one TBS scaling factor. The terminal device may determine the corresponding one or more TBS scaling factors from the at least one TBS scaling factor based on the indication information for one or more TBS scaling factors. Exemplary, if the at least one TBS scaling factor include 1, 0.5, and 0.125, and the indication information for multiple TBS scaling factors is 00, 01, and 10, then the terminal device determines that the corresponding multiple TBS scaling factors are 1, 0.5, and 0.125, respectively. Exemplary, if the at least one TBS scaling factor include 1, 0.5, and 0.125, and the indication information for multiple TBS scaling factors is 10, since the indication information less than or equal to 10 is 00, 01, and 10, the terminal device determines that the corresponding multiple TBS scaling factors are 1, 0.5, and 0.125, respectively.

In an example, the terminal device may determine the sixth TBS scaling factor from the one or more TBS scaling factors in the first set based on protocol specification, pre-configuration, or the instruction from the network device.

In an example, if the first indication information indicates the first set including multiple TBS scaling factors, in an embodiment, the terminal device may determine the sixth TBS scaling factor from the multiple TBS scaling factors included in the first set according to the indication of the first TB scaling domain in the DCI for scheduling the PDSCH. In other embodiments, the terminal device may determine the sixth TBS scaling factor from the multiple TBS scaling factors included in the first set according to the indication of other indication domains in the DCI for scheduling the PDSCH.

In some embodiments, the operation of the terminal device receiving, based on the sixth scaling factor, the PDSCH for which TBS scaling is performed includes that: the terminal device determines a seventh scaling factor based on the sixth scaling factor and the second scaling factor indicated by the DCI; and the terminal device receives, based on the seventh scaling factor, the PDSCH for which TBS scaling is performed.

In this way, for the network device side, the first set is used for the terminal device to determine the sixth scaling factor, and receive, based on the sixth scaling factor and the second scaling factor indicated by the DCI, the PDSCH for which TBS scaling is performed.

In an example, the seventh TBS scaling factor may be less than the sixth TBS scaling factor; or, the seventh TBS scaling factor may be greater than the sixth TBS scaling factor. In an example, the seventh TBS scaling factor may be less than the second TBS scaling factor; or, the seventh TBS scaling factor may be greater than the second TBS scaling factor.

In an example, the operation of the terminal device determining the seventh scaling factor based on the sixth scaling factor and the second scaling factor indicated by the DCI includes that: the terminal device determines the seventh scaling factor based on a product of the sixth scaling factor and the second scaling factor indicated by the DCI. In this way, for the network device side, the first set is used for the terminal device to determine the sixth scaling factor, and receive, based on the product of the sixth scaling factor and the second scaling factor indicated by the DCI, the PDSCH for which TBS scaling is performed.

In this way, the seventh TBS scaling factor is determined based on the product of the sixth TBS scaling factor and the second TBS scaling factor. For example, the seventh TBS scaling factor is the product of the sixth TBS scaling factor and the second TBS scaling factor. Other modes for determining the seventh TBS scaling factor are described below: in an example, the seventh TBS scaling factor is determined based on the sum of the sixth TBS scaling factor and the second TBS scaling factor. For example, the seventh TBS scaling factor is the sum of the sixth TBS scaling factor and the second TBS scaling factor. In an example, the seventh TBS scaling factor is determined based on the absolute value of the difference between the sixth TBS scaling factor and the second TBS scaling factor. For example, the seventh TBS scaling factor is the absolute value of the difference between the sixth TBS scaling factor and the second TBS scaling factor. In an example, the seventh TBS scaling factor is determined based on the result of dividing the smaller TBS scaling factor by the greater TBS scaling factor among the sixth TBS scaling factor and the second TBS scaling factor. For example, the seventh TBS scaling factor is the result of dividing the smaller TBS scaling factor by the greater TBS scaling factor among the sixth TBS scaling factor and the second TBS scaling factor. In an example, the seventh TBS scaling factor is the greater TBS scaling factor among the sixth TBS scaling factor and the second TBS scaling factor. In an example, the seventh TBS scaling factor is the smaller TBS scaling factor among the sixth TBS scaling factor and the second TBS scaling factor.

In an example, the sixth TBS scaling factor and the second TBS scaling factor may both be indicated by the DCI for scheduling the PDSCH. In an example, if the indication of the DCI for scheduling the PDSCH is 00, then the sixth TBS scaling factor is the first TBS scaling factor among one or more TBS scaling factors included in the first set, and the second TBS scaling factor is the first TBS scaling factor among multiple TBS scaling factors specified in the existing protocol.

In some embodiments, the operation of the terminal device receiving the PDSCH for which transport block size (TBS) scaling is performed includes that: the terminal device determines an eighth scaling factor based on a second set including one or more scaling factors. Herein the second set is specified in the protocol, or the second set is determined by the terminal device according to pre-configuration, or the second set is a set of default values. The terminal device receives, based on the eighth scaling factor, the PDSCH for which TBS scaling is performed.

In this way, for the network device side, the first indication information and/or the DCI is used for the terminal device to determine the eighth scaling factor based on the second set including one or more scaling factors, and receive, based on the eighth scaling factor, the PDSCH for which TBS scaling is performed. Herein the second set is specified in the protocol, or the second set is determined by the terminal device according to pre-configuration, or the second set is a set of default values.

In an example, in the case that the TBS scaling factor indicated by the first indication information and/or the DCI does not meet the requirements, or in the case that the first indication information does not indicate one or more TBS scaling factors, or in the case that the first TB scaling domain included in the DCI indicates an invalid value, or in the case that the DCI does not include the first TB scaling domain, the terminal device determines the eighth scaling factor based on the second set including one or more scaling factors, and further receives, based on the eighth scaling factor, the PDSCH for which TBS scaling is performed.

For example, in the case that the TBS scaling factor indicated by the first indication information does not meet the requirements, or in the case that the first indication information does not indicate one or more TBS scaling factors, regardless of whether the indication of the DCI for scheduling the PDSCH can indicate the second TBS scaling factor, the terminal device determines the eighth scaling factor based on the second set including one or more scaling factors, and further receives, based on the eighth scaling factor, the PDSCH for which TBS scaling is performed.

In this case, the eighth TBS scaling factor used by the terminal device may not be determined by the instruction of the network device, but determined based on one or more TBS scaling factors in the second set specified in the protocol or pre-configured. In other embodiments, the second set including one or more scaling factors may be indicated by the network device to the terminal device.

In an example, the second set may include one or more TBS scaling factors. For example, the first indication information or the third indication information may include the second set, and the TBS scaling factors in the second set are 1, 0.5, and 0.125, respectively. For another example, the first indication information or the third indication information includes indication information of the TBS scaling factor, which includes 00, 01, and 10. Based on the indication information of the TBS scaling factor, the terminal device determines that the TBS scaling factors in the second set are 1, 0.5, and 0.125, respectively.

In an example, in an embodiment, the terminal device may determine the eighth TBS scaling factor from the multiple TBS scaling factors included in the second set according to the indication of the first TB scaling domain in the DCI for scheduling the PDSCH. In other embodiments, the terminal device may determine the eighth TBS scaling factor from the multiple TBS scaling factors included in the second set according to the indication of another indication domain in the DCI for scheduling the PDSCH.

In some embodiments, the operation of the terminal device receiving, based on the eighth scaling factor, the PDSCH for which TBS scaling is performed includes the following actions.

The terminal device determines a ninth scaling factor based on the eighth scaling factor and the second scaling factor indicated by the DCI.

The terminal device receives, based on the ninth scaling factor, the PDSCH for which TBS scaling is performed.

In this way, for the network device side, the first indication information and/or the DCI is used for the terminal device to determine the eighth scaling factor based on the second set including one or more scaling factors, and receive, based on the eighth scaling factor and the second scaling factor indicated by the DCI, the PDSCH for which TBS scaling is performed.

In some embodiments, the operation of the terminal device determining the ninth scaling factor based on the eighth scaling factor and the second scaling factor indicated by the DCI includes that: the terminal device determines the ninth scaling factor based on a product of the eighth scaling factor and the second scaling factor indicated by the DCI.

In this way, the ninth TBS scaling factor is determined based on the product of the eighth TBS scaling factor and the second TBS scaling factor. For example, the ninth TBS scaling factor is the product of the eighth TBS scaling factor and the second TBS scaling factor. Other modes for determining the ninth TBS scaling factor are described below: in an example, the ninth TBS scaling factor is determined based on the sum of the eighth TBS scaling factor and the second TBS scaling factor. For example, the ninth TBS scaling factor is the sum of the eighth TBS scaling factor and the second TBS scaling factor. In an example, the ninth TBS scaling factor is determined based on the absolute value of the difference between the eighth TBS scaling factor and the second TBS scaling factor. For example, the ninth TBS scaling factor is the absolute value of the difference between the eighth TBS scaling factor and the second TBS scaling factor. In an example, the ninth TBS scaling factor is determined based on the result of dividing the smaller TBS scaling factor by the greater TBS scaling factor among the eighth TBS scaling factor and the second TBS scaling factor. For example, the ninth TBS scaling factor is the result of dividing the smaller TBS scaling factor by the greater TBS scaling factor among the eighth TBS scaling factor and the second TBS scaling factor. In an example, the ninth TBS scaling factor is the greater TBS scaling factor among the eighth TBS scaling factor and the second TBS scaling factor. In an example, the ninth TBS scaling factor is the smaller TBS scaling factor among the eighth TBS scaling factor and the second TBS scaling factor.

In an example, the eighth TBS scaling factor and the second TBS scaling factor may both be indicated by the DCI for scheduling the PDSCH (e.g., by the first TB scaling domain or another indication domain in the DCI for scheduling the PDSCH). In an example, if the DCI for scheduling the PDSCH indicates 10, then the eighth TBS scaling factor is the second TBS scaling factor among multiple TBS scaling factors included in the second set, and the second TBS scaling factor is the second TBS scaling factor among multiple TBS scaling factors specified in the existing protocol.

In an example, in some embodiments, in the case that the terminal device uses a certain TBS scaling factor indicated by the first indication information, the terminal device may send feedback information to the network device, and/or in the case that the terminal device does not use any TBS scaling factor indicated by the first indication information, the terminal device may not send feedback information to the network device. In other embodiments, in the case that the terminal device uses a certain TBS scaling factor indicated by the first indication information, the terminal device may not send feedback information to the network device, and/or, in the case that the terminal device does not use any TBS scaling factor indicated by the first indication information, the terminal device may send feedback information to the network device. In an example, the feedback information may or may not include the TBS scaling factor used by the terminal device. In this way, the terminal device sends or does not send feedback information to the network device based on that the terminal device uses a certain one of the one or more TBS scaling factors indicated by the first indication information, or based on that the terminal device does not use any one of the one or more TBS scaling factors not indicated by the first indication information, so that the network device may send the PDSCHs corresponding to the respective TBS scaling factors to different terminal devices based on TBS scaling factors used by different terminal devices. In an example, in the case that the terminal device does not use any one of the one or more TBS scaling factors indicated by the first indication information, the terminal device may use the TBS scaling factor specified in the protocol prior to the present disclosure, which will not be repeated in embodiments of the present disclosure.

In an exemplary implementation, the terminal device may obtain the one or more TBS scaling factors indicated by the first indication information, and may obtain the one or more TBS scaling factors indicated by the DCI for scheduling the PDSCH. In some embodiments, the terminal device may use a certain one of the one or more TBS scaling factors indicated by the first indication information. In an example, the terminal device may not use any one of the one or more TBS scaling factors indicated by the DCI for scheduling the PDSCH. In other embodiments, the terminal device may use a certain one of the one or more TBS scaling factors indicated by the DCI for scheduling the PDSCH. In an example, the terminal device may not use any one of the one or more TBS scaling factors indicated by the first indication information. In still other embodiments, the terminal device may determine a TBS scaling factor A (i.e., the sixth TBS scaling factor mentioned above) from the one or more TBS scaling factors indicated by the first indication information, determine a TBS scaling factor B (i.e., the second TBS scaling factor mentioned above) from the one or more TBS scaling factors indicated by the DCI for scheduling the PDSCH, and determine a scaling factor C used by the terminal device (i.e., the seventh TBS scaling factor mentioned above) based on TBS scaling factor A and the TBS scaling factor B.

In other embodiments, the first indication information may indicate one or more TBS scaling factors. In addition, the DCI for scheduling the PDSCH does not indicate one or more TBS scaling factors. In this way, the terminal device may obtain the one or more TBS scaling factors indicated by the first indication information, so that the terminal device may use a certain one of the one or more TBS scaling factors indicated by the first indication information.

In still other embodiments, there is no information other than the DCI for scheduling the PDSCH that may indicate one or more TBS scaling factors. In this way, the terminal device may obtain the one or more TBS scaling factors indicated by the DCI for scheduling the PDSCH, so that the terminal device may use a certain one of the one or more TBS scaling factors indicated by the DCI for scheduling the PDSCH.

In some embodiments, the sixth TBS scaling factor is determined by the indication of the DCI for scheduling the PDSCH. In some embodiments, the eighth TBS scaling factor is determined by the indication of the DCI for scheduling the PDSCH.

In an implementation, since the first indication information indicates the first set including multiple TBS scaling factors, and the terminal device does not know which one among the multiple TBS scaling factors in the first set to be determined as the sixth TBS scaling factor, therefore through the indication of the DCI for scheduling the PDSCH, the terminal device may determine the sixth TBS scaling factor from the multiple TBS scaling factors in the first set.

In an implementation, since the second set specified in the protocol or pre-configured by the terminal device includes multiple TBS scaling factors, and the terminal device does not know which one among the multiple TBS scaling factors in the second set to be determined as the eighth TBS scaling factor, therefore through the indication of the DCI for scheduling the PDSCH, the terminal device may determine the eighth TBS scaling factor from the multiple TBS scaling factors in the second set.

In some embodiments, the sixth TBS scaling factor is determined by the indication of the first TB scaling domain of the DCI for scheduling the PDSCH. In some embodiments, the eighth TBS scaling factor is determined by the indication of the first TB scaling domain of the DCI for scheduling the PDSCH.

In an example, in the case that the first TB scaling domain exists in the DCI for scheduling the PDSCH, the terminal device may determine the sixth TBS scaling factor and/or the eighth TBS scaling factor based on the value indicated by the first TB scaling domain in the DCI for scheduling the PDSCH.

For example, in the case that the value indicated by the first TB scaling domain is 00, the first TBS scaling factor among the multiple TBS scaling factors in the first set is determined as the sixth TBS scaling factor. For another example, in the case that the value indicated by the first TB scaling domain is 01, the second TBS scaling factor among the multiple TBS scaling factors in the first set is determined as the sixth TBS scaling factor.

For example, in the case that the value indicated by the first TB scaling domain is 00, the first TBS scaling factor among the multiple TBS scaling factors in the second set is determined as the eighth TBS scaling factor. For another example, in the case that the value indicated by the first TB scaling domain is 01, the second TBS scaling factor among the multiple TBS scaling factors in the second set is determined as the eighth TBS scaling factor.

In an example, the first TB scaling domain in the DCI for scheduling the PDSCH may be the TB scaling domain specified in the protocol prior to the present disclosure (existing protocol).

In some embodiments, the sixth TBS scaling factor is determined by the indication of a modulation coding scheme (MCS) domain in the DCI for scheduling the PDSCH. In some embodiments, the eighth TBS scaling factor is determined by the indication of the modulation coding scheme (MCS) domain in the DCI for scheduling the PDSCH.

In an example, in some embodiments, in the case that the first TB scaling domain does not exist in the DCI for scheduling the PDSCH, the terminal device may determine the sixth TBS scaling factor and/or the eighth TBS scaling factor based on the value indicated by the modulation coding scheme (MCS) domain in the DCI for scheduling the PDSCH.

In an example, in other embodiments, in the case that the DCI for scheduling the PDSCH is scrambled by at least one of the following: cell-radio network temporary identifier (C-RNTI), configured scheduling-radio network temporary identifier (CS-RNTI), modulation coding scheme-cell-radio network temporary identifier (MCS-C-RNTI), temporary cell-radio network temporary identifier (TC-RNTI), or system information-radio network temporary identifier (SI-RNTI), the terminal device may determine the sixth TBS scaling factor and/or the eighth TBS scaling factor based on the value indicated by the modulation coding scheme (MCS) domain in the DCI for scheduling the PDSCH.

In some embodiments, the MCS domain includes a first bit and a second bit; the first bit indicates the sixth TBS scaling factor and/or the eighth TBS scaling factor, and the second bit indicates an MCS corresponding to the PDSCH.

In an example, the first bit may be one bit or multiple bits. In an example, in the case that the first bit is multiple bits, the multiple bits may be consecutive bits.

In an example, the second bit may be one bit or multiple bits. In an example, in the case that the second bit is multiple bits, the multiple bits may be consecutive bits.

In an example, the first bit and the second bit may be adjacent bits, or the first bit and the second bit may be non-adjacent bits (i.e., there may be at least one bit gap between the first bit and the second bit). For example, the highest bit in the first bit is the N^{th} bit, and the lowest bit in the second bit is the (N+1)^{th} bit. For another example, the highest bit in the first bit is the N^{th} bit, and the lowest bit in the second bit is the (N+M)^{th} bit; and M is an integer greater than or equal to 2. In an example, at least one bit between the first bit and the second bit may be a reserved bit(s), or may be a bit(s) indicating other information (i.e., a significant bit(s)), or one part may be a reserved bit(s) and the other part may be a bit(s) indicating other information.

In an example, the first bit and/or the second bit may be a significant bit. In an example, the first bit may be a significant bit or multiple significant bits. In an example, in the case that the first bit is multiple significant bits, the multiple significant bits may be consecutive significant bits. In an example, the second bit may be a significant bit or multiple significant bits. In an example, in the case that the second bit is multiple significant bits, the multiple significant bits may be consecutive significant bits.

In an example, the first bit and the second bit do not overlap. For example, if the first bit is the first and second significant bits in the MCS domain, then the second bit cannot be the first and second significant bits in the MCS domain. In an example, the first bit and the second bit may overlap. For example, there may be an overlap of at least one bit (such as 1 bit or 2 bits, etc.) between the first bit and the second bit.

In some embodiments, the first bit is a first number of most significant bits (MSBs), and the second bit is a second number of least significant bits (LSBs). In other embodiments, the first bit is the first number of least significant bits (LSBs), and the second bit is the second number of most significant bits (MSBs).

In an example, the first number may be the number that may indicate the TBS scaling factors. In an example, the first number may be the same or different from the number for indicating TBS scaling factors specified in the protocol prior to the present disclosure. For example, the first number may be 1, 2, 3, 4, or 5, and so on. The second number may be 1, 2, 3, 4, or 5, and so on.

In some embodiments, the first bit is 2 most significant bits (MSBs), and the second bit is 3 least significant bits (LSBs). In other embodiments, the first bit is 2 least significant bits (LSBs), and the second bit is 3 most significant bits (MSBs). In an example, the MCS domain may include 5 significant bits.

In some embodiments, the terminal device obtains an MCS index set, and the second bit indicates an MCS corresponding to the PDSCH in the MCS index set.

In an example, the operation of the terminal device obtaining the MCS index set may include: the terminal device receives the MCS index set. In other embodiments, the method further includes that: the terminal device determines the MCS index set according to pre-configuration.

In this way, for the network device side, the method further includes that: the network device sends the MCS index set; and the second bit indicates the MCS corresponding to the PDSCH in the MCS index set.

In an example, the MCS index set in embodiments of the present disclosure may be the MCS index set that may be indicated by the second bit in the MCS domain. For example, the second bit in the MCS domain is three significant bits, and the MCS index set that the second bit may indicate includes 8 MCS indices.

In some embodiments, the sixth TBS scaling factor is determined by the indication of one or more reserved bits in the DCI for scheduling the PDSCH. In other embodiments, the one or more reserved bits in the DCI for scheduling the PDSCH are configured as a second TB scaling domain, and the sixth TBS scaling factor is determined according to an indication of the second TB scaling domain.

In some embodiments, the eighth TBS scaling factor is determined by the indication of one or more reserved bits in the DCI for scheduling the PDSCH. In other embodiments, the one or more reserved bits in the DCI for scheduling the PDSCH are configured as the second TB scaling domain, and the eighth TBS scaling factor is determined according to the indication of the second TB scaling domain.

In an example, in some embodiments, in the case that the first TB scaling domain does not exist in the DCI for scheduling the PDSCH, the terminal device may determine the sixth TBS scaling factor and/or the eighth TBS scaling factor based on the value indicated by the one or more reserved bits in the DCI for scheduling the PDSCH.

In an example, in other embodiments, in the case that the DCI for scheduling the PDSCH is scrambled by at least one of the following: cell-radio network temporary identifier (C-RNTI), configured scheduling-radio network temporary identifier (CS-RNTI), modulation coding scheme-cell-radio network temporary identifier (MCS-C-RNTI), temporary cell-radio network temporary identifier (TC-RNTI), or system information-radio network temporary identifier (SI-RNTI), the terminal device may determine the sixth TBS scaling factor and/or the eighth TBS scaling factor based on the value indicated by the one or more reserved bits in the DCI for scheduling the PDSCH.

In an example, all reserved bits in the DCI for scheduling the PDSCH may be at least one reserved bit, and the one or more reserved bits may be determined from the at least one reserved bit. In an example, the one or more reserved bits may be 1 bit, 2 bits, 3 bits, or 4 bits, and so on. Exemplary, the one or more reserved bits in embodiments of the present disclosure may be 2 bits.

In an example, the 2 bits may correspond to the 2 bits of the highest bit and the second-highest bit among all the reserved bits in the DCI for scheduling the PDSCH, or, may correspond to the 2 bits of the lowest bit and the second-lowest bit. In an example, the 2 bits may be 2 consecutive reserved bits among all the reserved bits in the DCI for scheduling the PDSCH, or may be 2 non-consecutive bits among all the reserved bits in the DCI for scheduling the PDSCH.

In an example, all the reserved bits in the DCI for scheduling the PDSCH may include a downlink assignment index (DAI) domain. In an example, one or more reserved bits may be determined from all the reserved bits in the DAI domain. In an example, all the reserved bits in the DAI domain may be at least one bit. For example, all the reserved bits in the DAI domain may be 1 bit, 2 bits, 3 bits, or 4 bits, and so on. Exemplary, all the reserved bits in the DAI domain may be 2 bits. In an example, the DAI domain in DCI/DCI 1_0 with CRC scrambled by TC-RNTI is a reserved bit(s).

In an example, all the reserved bits in the DCI for scheduling the PDSCH may include other reserved bits other than the DAI domain. In an example, one or more reserved bits may be determined from other reserved bits. In an example, other reserved bits may be at least one bit. In an example, other reserved bits may be 1 bit, 2 bits, 3 bits, or 4 bits, and so on. In an example, the 2 bits may correspond to the 2 bits of the highest bit and the second-highest bit among other reserved bits.

In an example, the second TB scaling domain may be one or more reserved bits determined in any of the above embodiments. In an example, the second TB scaling domain may be one or more of all the reserved bits in the DCI for scheduling the PDSCH. In an example, the second TB scaling domain may be: one or more of the reserved bits in the DAI domain in the DCI for scheduling the PDSCH. In an example, the second TB scaling domain may be: one or more of other reserved bits other than the DAI domain in the DCI for scheduling the PDSCH.

Taking DCI 1_0 with CRC scrambled by TC-RNTI as an example: in an example, one or more reserved bits in DCI 1_0 with CRC scrambled by TC-RNTI may indicate the sixth TBS scaling factor and/or the eighth TBS scaling factor. In an example, the DAI domain in DCI 1_0 with CRC scrambled by TC-RNTI may indicate the sixth TBS scaling factor and/or the eighth TBS scaling factor. In an example, in DCI 1_0 with CRC scrambled by TC-RNTI, one or more reserved bits other than the DAI domain may indicate the sixth TBS scaling factor and/or the eighth TBS scaling factor. In an example, the one or more reserved bits in DCI 1_0 with CRC scrambled by TC-RNTI, or the DAI domain in DCI 1_0 with CRC scrambled by TC-RNTI, or the one or more reserved bits other than the DAI domain in DCI 1_0 with CRC scrambled by TC-RNTI may be configured as the second TB scaling domain.

In some embodiments, 2 reserved bits included in the downlink assignment index (DAI) domain may be used to indicate the sixth TBS scaling factor or the eighth TBS scaling factor. In this case, the downlink assignment index (DAI) domain may include 2 reserved bits or more than 2 reserved bits.

In other embodiments, the downlink assignment index (DAI) domain may be configured as the second TB scaling domain. In an example, in the case that the downlink assignment index (DAI) domain includes two reserved bits, the two reserved bits in the downlink assignment index (DAI) domain may be configured as the second TB scaling domain. In an example, in the case that the downlink assignment index (DAI) domain includes more than two reserved bits, two reserved bits may be determined from the more than two reserved bits, and the domain corresponding to these two reserved bits may be configured as the second TB scaling domain.

In an example, the second TB scaling domain may be the TB scaling domain specified in the protocol after the present disclosure (the newly proposed solution in the present disclosure comparing to the existing protocol).

In some embodiments, the second indication information is used to request a new TBS scaling factor, which can be understood as the second indication information being used to request adjustment of the TBS scaling factor for the PDSCH. In an example, one or more TBS scaling factors indicated by the third indication information may be referred to as a new TBS scaling factor(s), or referred to as a TBS scaling factor(s) in the NTN system, or referred to as a TBS scaling factor(s) specified in a protocol different from the existing protocol.

In an example, the second indication information may be explicit information, which indicates: requesting TBS scaling for the PDSCH or requesting a new TBS scaling factor. For example, the second indication information may include one or more bits, and it is indicated by setting the one or more bits to a specific value: requesting TBS scaling for the PDSCH, or requesting a new TBS scaling factor.

In an example, the second indication information may be implicit information. For example, the second indication information may implicitly indicate: requesting TBS scaling for the PDSCH or requesting a new TBS scaling factor.

In some embodiments, the second indication information is carried through a physical random access channel (PRACH). For example, the second indication information is information in the PRACH. In an example, the second indication information is explicitly carried through the PRACH, or the second indication information is implicitly carried through the PRACH.

In other embodiments, the second indication information may be included in other uplink information. For example, the uplink information may be included in the Msg1, Msg3, MsgA, or uplink control information.

In some embodiments, the terminal device sending the second indication information includes: the terminal device sends the PRACH on a first random access resource; and indicates, through the PRACH corresponding to the first random access resource, a request for TBS scaling for the PDSCH or a request for a new TBS scaling factor.

In this way, for the network device side, the network device receives the PRACH on the first random access resource, where the PRACH corresponding to the first random access resource indicates a request for TBS scaling for the PDSCH or a request for a new TBS scaling factor.

In an example, the first random access resource may include at least one of the following: a time domain resource for the first random access, a frequency domain resource for the first random access, a random access resource corresponding to the first PRACH format, a random access resource corresponding to the first random access channel occasion (RACH occasion, RO), or a random access resource corresponding to the first PRACH preamble. In an example, the first random access resource may also include other resources, which are not listed in detail in embodiments of the present disclosure.

In an example, the first PRACH format may be referred to as the first preamble format in other embodiments.

In some embodiments, the operation of the terminal device sending the second indication information includes that: the terminal device sends the PRACH corresponding to a first PRACH format; and indicates, through the PRACH corresponding to the first PRACH format, a request for TBS scaling for the PDSCH or a request for a new TBS scaling factor.

In this way, for the network device side, the operation of the network device receiving the second indication information includes that: the network device receives the PRACH corresponding to the first PRACH format, where the PRACH corresponding to the first PRACH format indicates a request for TBS scaling for the PDSCH or a request for a new TBS scaling factor.

In some embodiments, the operation of the terminal device sending the second indication information includes that: the terminal device sends the PRACH within the first random access channel occasion (RO); and indicates, through the PRACH corresponding to the first RO, a request for TBS scaling for the PDSCH or a request for a new TBS scaling factor.

In this way, for the network device side, the operation of the network device receiving the second indication information includes that: the network device receives the PRACH within a first random access channel occasion (RO), where the PRACH corresponding to the first RO indicates a request for TBS scaling for the PDSCH or a request for a new TBS scaling factor.

In some embodiments, the operation of the terminal device sending the second indication information includes that: the terminal device sends the PRACH including the first PRACH preamble; and indicates, through the PRACH including the first PRACH preamble, a request for TBS scaling for the PDSCH or a request for a new TBS scaling factor.

In this way, for the network device side, the network device receives the PRACH including the first PRACH preamble, where the PRACH including the first PRACH preamble indicates a request for TBS scaling for the PDSCH or a request for a new TBS scaling factor.

In some embodiments, at least one of the first random access resource, the first PRACH format, the first RO, or the first PRACH preamble is specified in the protocol, or is determined by the terminal device according to pre-configuration, or is configured by the network device to the terminal device.

In some embodiments, the DCI for scheduling the PDSCH contains the first transport block (TB) scaling domain. In other embodiments, the downlink control information (DCI) for scheduling the PDSCH is scrambled by at least one of the following: paging-radio network temporary identifier (P-RNTI), random access-radio network temporary identifier (RA-RNTI), or MsgB-radio network temporary identifier (MsgB-RNTI).

In an example, the first TB scaling domain is one or more bits. For example, the first TB scaling domain is 2 bits, and different values in the first TB scaling domain may indicate different TBS scaling factors.

In an example, the DCI for scheduling the PDSCH is scrambled by at least one of the following: paging-radio network temporary identifier (P-RNTI), random access-radio network temporary identifier (RA-RNTI), or MsgB-radio network temporary identifier (MsgB-RNTI), which may correspond to the DCI for scheduling the PDSCH containing the first TB scaling domain. In this way, the first TB scaling domain may indicate the TBS scaling factor in existing protocols, and/or may indicate the TBS scaling factor in future protocols (i.e., protocols after the present disclosure). In an example, in the case that the first indication information or the third indication information indicates a TBS scaling factor (which may be a scaling factor in the future protocol), the first TB scaling domain indicates the TBS scaling factor in the existing protocol, but not in the future protocol. In an example, in the case that the first indication information or the third indication information indicates multiple TBS scaling factors (which may be the scaling factor in the future protocol), the first TB scaling domain may indicate the TBS scaling factor in the existing protocol, or may indicate a certain one of multiple TBS scaling factors in the future protocol. That is to say, the first TB scaling domain may indicate the TBS scaling factors in both the existing protocol and the future protocol.

In an example, the first TB scaling domain may indicate a certain one of one or more TBS scaling factors. In an example, the one or more TBS scaling factors that include the TBS scaling factor indicated by the first TB scaling domain may be at least one of the following: one or more TBS scaling factors specified in the protocol prior to the present disclosure, one or more TBS scaling factors specified in the protocol after the present disclosure, one or more TBS scaling factors indicated by the first indication information or the third indication information, or one or more TBS scaling factors pre-configured by the terminal device.

In any embodiment of the present disclosure, the DCI scrambled by at least one of P-RNTI, RA-RNTI, or MsgB-RNTI may be understood in the same way as DCI/DCI 1_0 with CRC scrambled by at least one of P-RNTI, RA-RNTI, or MsgB-RNTI.

In some embodiments, the DCI for scheduling the PDSCH does not contain the first TB scaling domain. In other embodiments, the DCI for scheduling the PDSCH is scrambled by at least one of the following: cell-radio network temporary identifier (C-RNTI), configured scheduling-radio network temporary identifier (CS-RNTI), modulation coding scheme-cell-radio network temporary identifier (MCS-C-RNTI), temporary cell-radio network temporary identifier (TC-RNTI), or system information-radio network temporary identifier (SI-RNTI).

In an example, the DCI for scheduling the PDSCH is scrambled by at least one of the following: cell-radio network temporary identifier (C-RNTI), configured scheduling-radio network temporary identifier (CS-RNTI), modulation coding scheme-cell-radio network temporary identifier (MCS-C-RNTI), temporary cell-radio network temporary identifier (TC-RNTI), or system information-radio network temporary identifier (SI-RNTI), which may correspond to the DCI for scheduling the PDSCH does not contain the first TB scaling domain.

In an example, in the case that the DCI for scheduling the PDSCH does not contain the first TB scaling domain, other indication domains in the DCI for scheduling the PDSCH may be used to indicate a certain one of the one or more TBS scaling factors.

In an example, the one or more TBS scaling factors that include the TBS scaling factor indicated by other indication domains may be at least one of the following: one or more TBS scaling factors specified in the protocol prior to the present disclosure, one or more TBS scaling factors specified in the protocol after the present disclosure, one or more TBS scaling factors indicated in the first indication information or the third indication information, or one or more TBS scaling factors pre-configured by the terminal device.

In some implementations, in the case that the DCI for scheduling the PDSCH does not contain the first TB scaling domain, the terminal device may use the TBS scaling factor indicated by the first indication information or the third indication information. This way, since the first indication information or the third indication information indicates the TBS scaling factor, there is no need for the first TB scaling domain to indicate which TBS scaling factor to use. Or, the terminal device may use a certain one of multiple TBS scaling factors indicated by the first indication information or the third indication information, and the terminal device may determine the certain one of multiple TBS scaling factors through the indication of other indication domains, e.g., through the indication of other indication domains in the DCI for scheduling the PDSCH.

In any embodiment of the present disclosure, the DCI scrambled by at least one of C-RNTI, CS-RNTI, MCS-C-RNTI, TC-RNTI, or SI-RNTI may be understood in the same way as DCI/DCI 1_0 with CRC scrambled by at least one of C-RNTI, CS-RNTI, MCS-C-RNTI, TC-RNTI, or SI-RNTI.

The following explains the implementation of the present disclosure from another aspect.

Embodiments of the present disclosure provide a TBS scaling solution for the PDSCH, for a PDSCH that supports TBS scaling, the TBS scaling factors may be further adjusted; and for a PDSCH that does not support TBS scaling, the TBS scaling solution may be introduced. In any embodiment of the present disclosure, adjusting the TBS scaling factor may be understood as setting a TBS scaling factor different from that in the existing protocol.

In related art, DCI 1_0 with CRC scrambled by P-RNTI, RA-RNTI, or MsgB-RNTI contains a 2-bit TB scaling domain (i.e., the first TB scaling domain mentioned above), to indicate different TBS scaling factors in Table 1, thereby supporting the TBS scaling solution for scheduling the PDSCH. Table 1 shows correspondences between values of the TB scaling domain and scaling factors provided in related art:

TABLE 1

| TB Scaling Domain | Scaling factor |
|---|---|
| 00 | 1 |
| 01 | 0.5 |
| 10 | 0.25 |
| 11 | |

The enhanced TBS scaling solutions are described below.

For the PDSCH scheduled by DCI 1_0 with CRC scrambled by P-RNTI, RA-RNTI, or MsgB-RNTI, the currently supported TBS scaling factor S may reduce TBS by up to ¼. For some communication scenarios with limited coverage performance, such as the NTN system, further adjustment of the TBS scaling factor S can be considered to improve coverage performance.

The terminal device may decide whether to request to adjust the TBS scaling factor from the network device (corresponding to the second indication information mentioned above) based on the current coverage situation and whether it has the capability to adjust/use the TBS scaling factor. Here, the terminal device may implicitly request to adjust the TBS scaling factor through specified random access resources. For example, the terminal device uses a specified PRACH format, sends a PRACH within a specified RO, or sends a specified PRACH preamble, to implicitly request the network device to adjust the TBS scaling factor.

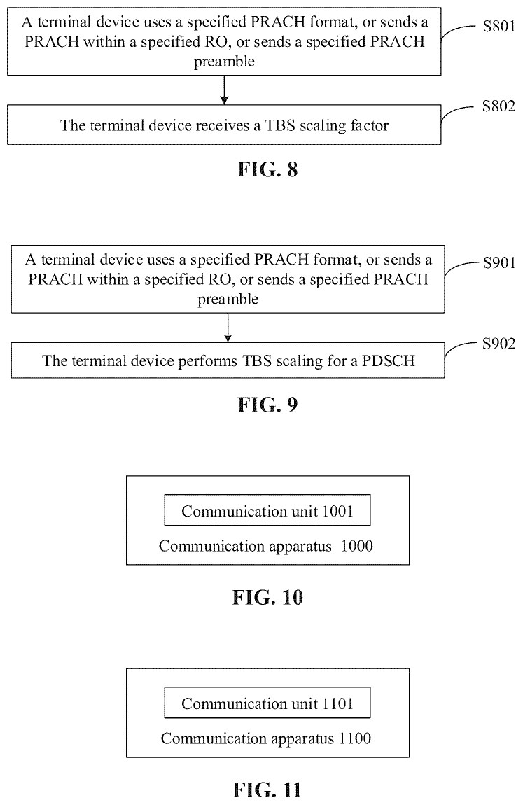

FIG. 8 is a schematic flowchart for a terminal device receiving a TBS scaling factor provided by an embodiment of the present disclosure. As illustrated in FIG. 8, the method includes the following operations.

At S801, the terminal device uses a specified PRACH format, or sends a PRACH within a specified RO, or sends a specified PRACH preamble.

At S802, the terminal device receives a TBS scaling factor.

In an example, the TBS scaling factor received by the terminal device may be one or more adjusted TBS scaling factors.

There are following specific design solutions for adjusting the TBS scaling factor: a TBS scaling factor is broadcasted through system information, and an adjusted TBS scaling factor is introduced into a protocol.

The solution that the TBS scaling factor is broadcasted through system information is described below.

The network device may broadcast the TBS scaling factor through the system information and it may be applied to the terminal device requesting adjustment of the TBS scaling factor. Furthermore, for the solution of system information broadcasting TBS scaling factor, there can be the following solutions:
Solution 1.1: the system information broadcasts one TBS scaling factor.

The system information broadcasts a TBS scaling factor S₁ (i.e., the first TBS scaling factor mentioned above), and after requesting to adjust the TBS scaling factor, the terminal device may apply the TBS scaling factor S₁ broadcasted through the system information. Considering that DCI 1_0 in related art also indicates a TBS scaling factor S₂ (i.e., the third TBS scaling factor mentioned above). Therefore, the TBS scaling factor S final applied by the TBS scaling process N_{info}=S·N_{RE}·R·Qₘ·v may be determined based on the following solution.
Solution 1.1-1: Broadcasted TBS scaling factor S₁ replaces the TBS scaling factor S₂ indicated by DCI 1_0. That is, if the terminal device requests to adjust the TBS scaling factor, then the final applied TBS scaling factor S is equal to the scaling factor S₁ configured through the system information; otherwise, the TBS scaling factor S is still determined based on the indication of the TB scaling domain in DCI 1_0.
Solution 1.1-2: Broadcasted TBS scaling factor S₁ is combined with the TBS scaling factor S₂ indicated by DCI 1_0 to determine the final applied TBS scaling factor S (i.e., the second TBS scaling factor mentioned above), e.g., S=S₁·S₂. That is, if the terminal device requests to adjust the TBS scaling factor, then the final applied TBS scaling factor S is determined based on the TBS scaling factor S₁ configured through the system information and the TBS scaling factor S₂ indicated by DCI 1_0; otherwise, the TBS scaling factor S is still determined based on the indication of the TB scaling domain in DCI 1_0.

Taking N_{RE}=1560, R=120/1024, Qₘ=2, v=1 for example, the system message broadcasted TBS scaling factor S₁=0.125, and the TB scaling domain in DCI 1_0 indicated TBS scaling factor S₂=0.5.

If the terminal device requests to adjust the TBS scaling factor through a specified random access resource, then for solution 1, the terminal device takes S₁ as the final applied TBS scaling factor, i.e., N_{info}=S₁·N_{RE}·R·Qₘ·v=0.125·1560·120/1024·2·1=45.7. For solution 2, the terminal devices combines S₁ and S₂ to determine the final applied TBS scaling factor, that is N_{info}=S₁·S₂·N_{RE}·R·Qₘ·v=0.125·0.5·1560·120/1024·2·1=22.8.

If the terminal device does not request to adjust the TBS scaling factor, then the final applied TBS scaling factor is determined based on the indication of the TB scaling domain in DCI 1_0, i.e., N_{info}=S₂·N_{RE}·R·Qₘ·v=0.5·1560·120/1024·2·1=182.8.

It should be noted that if the terminal device requests to adjust the TBS scaling factor, but the system information does not configure the corresponding value, a fixed value (i.e., the fourth TBS scaling factor mentioned above) will be provided, such as 0.125, as the default value for the broadcasted TBS scaling factor S₁. In this way, as the network device receives a request from the terminal device for the TBS scaling factor, the network device will also use the fourth TBS scaling factor according to the protocol or pre-configuration.
Solution 1.2: the system information broadcasts multiple TBS scaling factors.

The system information broadcasts multiple TBS scaling factors S={S₁, S₂, . . . } (i.e., the first set mentioned above), and after requesting to adjust the TBS scaling factor, the terminal device may apply the multiple TBS scaling factors S={S₁, S₂, . . . } broadcasted through the system information, and further indicate the final applied TBS scaling factor (i.e., the sixth TBS scaling factor mentioned above) from S through the TB scaling domain in DCI 1_0.

For example, the network device broadcasts a TBS scaling factor set S={S₁=0.125, S₂=0.0625, S₃=0.03125} through the system information. For the terminal device requesting to adjust the TBS scaling factor, the broadcasted TBS scaling factor set S may be applied, and the applied specific value may be determined from S based on the indication of TB scaling domain in DCI 1_0. In particular, 00 indicates the first value S₁=0.125 of the set S, 01 indicates the second value S₂=0.0625 of the set S, and 10 indicates the third value S₃=0.03125 of the set S. For the terminal device that does not request to adjust the TBS scaling factor, the final applied TBS scaling factor is still indicated from the candidate values supported by the existing protocol. Table 2 shows correspondences between the values of the TB scaling domain and corresponding scaling factors after not requesting to adjust the TBS scaling factor, as well as correspondences between the values of the TB scaling domain and corresponding scaling factors after requesting to adjust the TBS scaling factor.

TABLE 2

| TB | Scaling Factor (not | |
|---|---|---|
| Scaling | requesting to adjust the | Scaling factor (requesting to |
| Domain | TBS scaling factor) | adjust the TBS scaling factor) |
| 00 | 1 | The first value of the broadcasted |
| | | TBS scaling factor |
| 01 | 0.5 | The second value of the broadcasted |
| | | TBS scaling factor |
| 10 | 0.25 | The third value of the broadcasted |
| | | TBS scaling factor |
| 11 | | |

It should be noted that if the terminal device requests to adjust the TBS scaling factor, but the system information does not configure the corresponding value, a fixed set of TBS scaling factors (i.e., the second set mentioned above) will be provided, such as a set S′={S′₁=0.125, S′₂=0.0625, S′₃=0.03125}, as the default value set for the broadcasted TBS scaling factor. Similarly, the applied specific value is determined from S′ based on the indication of TB scaling domain in DCI 1_0: 00 indicates the first value S′₁=0.125 of the set S′, 01 indicates the second value S′₂=0.0625 of the set S′, and 10 indicates the third value S′₃=0.03125 of the set S′. Table 3 shows correspondences between the values of the TB scaling domain and corresponding scaling factors after requesting to adjust the TBS scaling factor and the network device configuring the TBS scaling factor set, as well as correspondences between the values of the TB scaling domain and corresponding scaling factors after requesting to adjust the TBS scaling factor and the network device not configuring the TBS scaling factor set.

TABLE 3

| | Scaling Factor | | Scaling factor (requesting |
|---|---|---|---|
| | (not requesting | Scaling factor (requesting to adjust | to adjust the TBS scaling |
| TB | to adjust the | the TBS scaling factor and the | factor and the network |
| Scaling | TBS scaling | network device configuring the | device not configuring the |
| Domain | factor) | TBS scaling factor set) | TBS scaling factor set) |
| 00 | 1 | The first value of the broadcasted | 0.125 |
| | | TBS scaling factor | |
| 01 | 0.5 | The second value of the broadcasted | 0.0625 |
| | | TBS scaling factor | |
| 10 | 0.25 | The third value of the broadcasted | 0.03125 |
| | | TBS scaling factor | |
| 11 | | | |

The solution of protocol introduced adjusted TBS scaling factor is described below:

On the basis of the TBS scaling factor candidate values supported by the existing protocol, a set of adjusted TBS scaling factor candidate values {S₁, S₂, . . . } (i.e., the second set mentioned above) is additionally introduced. At this point, if the terminal device does not request to adjust the TBS scaling factor, the TBS scaling factor candidate values {1,0.5,0.25} supported by the existing protocol are applied; if the terminal device requests to adjust the TBS scaling factor, the newly introduced TBS scaling factor candidate values {S₁, S₂, . . . } are applied, e.g., {S₁=0.125, S₂=0.0625, S₃=0.03125}. Similarly, final applied TBS scaling factor is indicated based on the TB scaling domain in DCI 1_0. Table 4 shows correspondences between the values of the TB scaling domain and corresponding scaling factors after not requesting to adjust the TBS scaling factor, as well as correspondences between the values of the TB scaling domain and corresponding scaling factors after requesting to adjust the TBS scaling factor.

TABLE 4

| | Scaling Factor (not | Scaling factor (requesting |
|---|---|---|
| TB Scaling | requesting to adjust the | to adjust the TBS scaling |
| Domain | TBS scaling factor) | factor) |
| 00 | 1 | 0.125 |
| 01 | 0.5 | 0.0625 |
| 10 | 0.25 | 0.03125 |
| 11 | | |

Through the above solutions, it may adjust the TBS scaling factor in the existing protocol, effectively improving coverage performance by supporting smaller TBS scaling factors.

The solutions supported by TBS scaling solutions are described below.

The TBS scaling solution is currently not supported for the PDSCH scheduled by DCI 1_0 with CRC scrambled by RNTI other than P-RNTI, RA-RNTI, and MsgB-RNTI, such as C-RNTI, CS-RNTI, MCS-C-RNTI, TC-RNTI, or SI-RNTI. In some communication scenarios with limited coverage performance, such as the NTN system, it is considered to introduce the TBS scaling solution for the PDSCH scheduled by DCI 1_0 with CRC scrambled by RNTI mentioned above, in order to improve coverage performance.

The terminal device may decide whether to request for TBS scaling from the network device based on the current coverage situation and whether it has the TBS scaling capability for the corresponding PDSCH. Here, the terminal device may implicitly request to perform TBS scaling for the PDSCH through specified random access resources. For example, the terminal device uses a specified PRACH format, sends a PRACH within a specified RO, or sends a specified PRACH preamble, to implicitly request the network device for TBS scaling.

FIG. 9 is a schematic flowchart for a terminal device performing TBS scaling for a PDSCH provided by an embodiment of the present disclosure. As illustrated in FIG. 9, the method includes the following operations.

At S901, the terminal device uses a specified PRACH format, or sends a PRACH within a specified RO, or sends a specified PRACH preamble.

At S902, the terminal device performs TBS scaling for a PDSCH.

Since DCI 1_0 with CRC scrambled by these RNTIs currently does not contain a TB scaling domain (i.e., the first TB scaling domain mentioned above), it cannot indicate to determine the TBS scaling factor. Firstly, there can be the following solutions for determining the TBS scaling factor.
Solution 2.1: the system information broadcasts one TBS scaling factor.

The system information broadcasts a TBS scaling factor S, and after requesting for TBS scaling, the terminal device may apply the TBS scaling factor S broadcasted through the system information, and perform TBS scaling for the PDSCH based on this scaling factor, i.e., N_{info}=S·N_{RE}·R·Qₘ·v. If the system information does not configure the TBS scaling factor, a fixed value will be provided, such as 0.5, as the default value for the broadcasted TBS scaling factor S.

Taking N_{RE}=1560, R=120/1024, Qₘ=2, v=1 for example, if the terminal device requests to perform TBS scaling for the PDSCH through a specified random access resource, and the system information broadcasted TBS scaling factor S=0.25, then the terminal device will introduce the scaling factor into the calculation process of TBS, i.e., N_{info}=S·N_{RE}·R·Qₘ·v=0.25·1560·120/1024·2·1=91.4.
Solution 2.2: the system information broadcasts multiple TBS scaling factors.

The system information broadcasts multiple TBS scaling factors S={S₁, S₂, . . . }, and after requesting for TBS scaling, the terminal device may apply the TBS scaling factor set S={S₁, S₂, . . . } broadcasted by the system information. If the system information does not configure the TBS scaling factor, a fixed set of TBS scaling factors will be provided, such as the set S′={S′₁=0.125, S′₂=0.0625, S′₃=0.03125} as the default value set for the broadcasted TBS scaling factor.
Solution 2.3: the protocol introduces TBS scaling factor candidate values.

Introduce a set of TBS scaling factor candidate values in the protocol to support the TBS scaling solution for the PDSCH scheduled by DCI 1_0 with CRC scrambled by RNTI mentioned above. After requesting for TBS scaling, the terminal device may apply the introduced TBS scaling factor candidate values. Here, the set of candidate values may be TBS scaling factor candidate values {1,0.5,0.25} supported by the existing protocol, i.e., the TBS scaling factors corresponding to P-RNTI, RA-RNTI, and MsgB-RNTI in Table 1. It may also be a new TBS scaling factor candidate value introduced for the PDSCH scheduled by DCI 1_0 with CRC scrambled by RNTI mentioned above, for example {0.125,0.0625,0.03125}. Table 5 shows the TBS scaling factors for the PDSCH:

TABLE 5

| Scaling factor corresponding | Scaling factor corresponding to |
|---|---|
| to P-RNTI, RA-RNTI, and | C-RNTI, CS-RNTI, MCS-C-RNTI, |
| MsgB-RNTI | TC-RNTI, or SI-RNTI |
| 1 | 0.125 |
| 0.5 | 0.0625 |
| 0.25 | 0.03125 |

It should be noted that for solutions 2.2 and 2.3, due to the presence of multiple TBS scaling factors, it is necessary to further indicate the final applied value through DCI 1_0. Considering that there is no TB scaling domain in DCI 1_0 with CRC scrambled by RNTI mentioned above, there are the following solutions for indicating the TBS scaling factor.

The existing domain in DCI 1_0 with CRC scrambled by RNTI mentioned above is reinterpreted to indicate the TBS scaling factor to be applied. For example, the 5-bit MCS domain in DCI 1_0 may be reinterpreted to indicate both of the MCS and TBS scaling factor corresponding to the PDSCH scheduled by DCI 1_0.

For example, after requesting for TBS scaling, the terminal device first determines the TBS scaling factor set through solution 2.2 or 2.3, e.g., S={S₁=1, S₂=0.5, S₃=0.25}, and then further indicates the applied TBS scaling factor through the 2 most significant bits (MSBs) of the MCS domain in DCI 1_0, such as 00 indicating the first value S₁ of the set S, 01 indicating the second value S₂ of the set S, and 10 indicating the third value S₃ of the set S. Table 6 shows the scaling factors indicated by 2 MSBs of the MCS domain in DCI 1_0:

TABLE 6

| 2 MSBs of MCS Domain | Scaling factor |
|---|---|
| 00 | 1 |
| 01 | 0.5 |
| 10 | 0.25 |
| 11 | |

Also, the terminal device determines the MCS corresponding to the PDSCH through 3 least significant bits (LSBs) of the MCS domain in DCI 1_0. Considering that the original 5-bit MCS domain may indicate MCS indices 0-28, while 3 LSBs may indicate up to 8 MCS indices, the network device needs to configure a set of MCS index candidate values MCS={MCS₁, . . . , MCS₇} through high-level parameters. Then the specific applied MCS index is indicated from this set of MCS index candidate values MCS by the 3 LSBs of the MCS domain in DCI 1_0. It should be noted that if there is no set of MCS index candidate values MCS configured, a fixed set of MCS index candidate values should be provided, such as a set MCS′={MCS′₁, . . . , MCS′₇} as the default set of MCS index candidate values. Table 7 shows MCS indices indicated by the 3 LSBs of the MCS domain in DCI 1_0:

TABLE 7

| 3 LSBs | | Not configuring a |
|---|---|---|
| of MCS | Configuring a set of MCS index | set of MCS index |
| Domain | candidate values | candidate values |
| 000 | The first value of the set of MCS | 0 |
| | index candidate values | |
| 001 | The second value of the set of MCS | 1 |
| | index candidate values | |
| 010 | The third value of the set of MCS | 2 |
| | index candidate values | |
| 011 | The fourth value of the set of MCS | 3 |
| | index candidate values | |
| 100 | The fifth value of the set of MCS | 4 |
| | index candidate values | |
| 101 | The sixth value of the set of MCS | 5 |
| | index candidate values | |
| 110 | The seventh value of the set of MCS | 6 |
| | index candidate values | |
| 111 | The eighth value of the set of MCS | 7 |
| | index candidate values | |

Or, the TB scaling domain may be introduced in DCI 1_0 with CRC scrambled by RNTI mentioned above. Taking DCI 1_0 with CRC scrambled by TC-RNTI as an example, its current downlink assignment index (DAI) domain is 2 reserved bits, which may be used to introduce a TB scaling field to indicate the applied TBS scaling factor. That is, if the terminal device requests for TBS scaling, the DAI domain is 0 bits and the TB scaling domain is 2 bits to indicate the applied TBS scaling factor; if the terminal device does not request for TBS scaling, the DAI domain remains 2 reserved bits, and the TB scaling domain is 0 bits.

For example, after requesting for TBS scaling, the terminal device first determines the TBS scaling factor set S={S₁=1, S₂=0.5, S₃=0.25} through solution 2.2 or 2.3, and then indicates the applied TBS scaling factor through the TB scaling domain introduced in DCI 1_0, such as 00 indicating the first value S₁ of the set, 01 indicating the second value S₂ of the set, and 10 indicating the third value S₃ of the set. Table 8 shows correspondences between values of the TB scaling domains introduced in DCI 1_0 and scaling factors:

TABLE 8

| TB Scaling Domain | Scaling factor |
|---|---|
| 00 | 1 |
| 01 | 0.5 |
| 10 | 0.25 |
| 11 | |

Embodiments of the present disclosure provide a TBS scaling solution for the PDSCH, for a PDSCH that supports TBS scaling, the TBS scaling factors are further adjusted; and for a PDSCH that does not support TBS scaling, the TBS scaling solution is introduced. Thus the coverage performance of the PDSCH is effectively improved.

Furthermore, the system information broadcasts one or more TBS scaling factors, which may achieve more flexible TBS scaling factor configuration; and the protocol introduces the TBS scaling factor, which may achieve TBS scaling factor adjustment without increasing signaling overhead.

For the indication solution of the TBS scaling factor, reinterpreting the existing domain in DCI does not require introducing a new domain, which may save DCI signaling overhead. Introducing the TB scaling domain may ensure that the indication function of the existing domain is not affected.

Embodiments of the present disclosure may be designed based on the NTN system and the PDSCH scheduled by DCI 1_0, and may be extended to any system that applies the PDSCH TBS scaling solution, such as the NR system, the LTE system, etc.

Preferred embodiments of the present disclosure are described in detail in conjunction with the accompanying drawings. However, the present disclosure is not limited to the specific details of the above implementations. Within the scope of the technical conception of the present disclosure, various simple modifications may be made to the technical solution of the present disclosure, and these simple modifications all belong to the scope of protection of the present disclosure. For example, each of the specific technical features described in the above specific implementations may be combined in any suitable manner without contradiction, and various possible combinations are not further described in the present disclosure in order to avoid unnecessary repetition. For another example, various different implementations of the present disclosure may be arbitrarily combined, so long as it does not depart from the idea of the present disclosure and it should also be considered as the content of the present disclosure. For another example, provided that there is no conflict, the various embodiments described in the present disclosure and/or the technical features in each embodiment may be arbitrarily combined with related art, and the resulting technical solution should also fall within the scope of protection of the present disclosure.

It should also be understood that in various method embodiments of the present disclosure, the size of the sequence number of the above processes does not mean the order of execution, and the execution order of each process should be determined according to its function and inherent logic, and should not constitute any limitation on the implementation of embodiments of the present disclosure. Further, in embodiments of the present disclosure, the terms “downlink”, “uplink” and “sidelink” are used to represent the transmission direction of the signal or data, herein “downlink” is used to represent that the transmission direction of the signal or data is a first direction sent from a site to a user device of a cell, “uplink” is used to represent that the transmission direction of the signal or data is a second direction sent from the user device of the cell to the site, and “sidelink” is used to represent that the transmission direction of the signal or data is a third direction sent from a user device 1 to a user device 2. For example, “downlink signal” represents that the transmission direction of the signal is the first direction. In addition, in embodiments of the present disclosure, the term “and/or” is only an association relationship describing associated objects and represents that three relationships may exist. Specifically, A and/or B may represent three conditions: i.e., independent existence of A, existence of both A and B and independent existence of B. In addition, character “/” in the present disclosure usually represents that previous and next associated objects form an “or” relationship.

FIG. 10 is a first schematic structural composition diagram of a communication apparatus provided by an embodiment of the present disclosure. As illustrated in FIG. 10, the communication apparatus 1000 includes a communication unit 1001. The communication unit 1001 is configured to receive system information. Herein the system information carries first indication information. The communication unit 1001 is further configured to receive downlink control information (DCI) for scheduling a physical downlink shared channel (PDSCH). The communication unit 1001 is further configured to receive, based on the first indication information and/or the DCI, the PDSCH for which transport block size (TBS) scaling is performed.

In an example, the communication apparatus 1000 further includes a determining unit. The determining unit is configured to determine a scaled TBS, and then receive, based on the scaled TBS, the PDSCH for which TBS scaling is performed.

In some embodiments, the first indication information indicates one or more TBS scaling factors for the PDSCH; or, the first indication information does not indicate the one or more TBS scaling factors for the PDSCH.

In some embodiments, the DCI includes a first TB scaling domain. Herein the first TB scaling domain indicates one or more TBS scaling factors for the PDSCH or an invalid value, and the invalid value is an invalid TBS scaling factor or is null; or, the DCI does not include the first TB scaling domain.

In some embodiments, the communication unit 1001 is further configured to send second indication information based on the first indication information. The second indication information is used to request transport block size (TBS) scaling for the physical downlink shared channel (PDSCH), or to request a new TBS scaling factor.

The communication unit 1001 is further configured to receive third indication information.

The communication unit 1001 is further configured to receive, based on the third indication information and/or the DCI, the PDSCH for which TBS scaling is performed.

In some embodiments, the communication unit 1001 is further configured to: receive, based on a first scaling factor indicated by the first indication information or the third indication information, the PDSCH for which TBS scaling is performed.

In some embodiments, the communication unit 1001 is further configured to: receive, based on a second scaling factor indicated by the DCI, the PDSCH for which TBS scaling is performed.

In some embodiments, the communication unit 1001 is further configured to: receive, based on the first scaling factor indicated by the first indication information or the third indication information and the second scaling factor indicated by the DCI, the PDSCH for which TBS scaling is performed.

In some embodiments, the determining unit is further configured to: determine a third scaling factor based on a product of the first scaling factor indicated by the first indication information or the third indication information and the second scaling factor indicated by the DCI; and the communication unit 1001 is further configured to: receive, based on the third scaling factor, the PDSCH for which TBS scaling is performed.

In some embodiments, the communication unit 1001 is further configured to: receive, based on a fourth scaling factor, the PDSCH for which TBS scaling is performed. Here the fourth scaling factor is a positive number with a value range greater than 0 and less than or equal to 1.

In some embodiments, the determining unit is further configured to: determine a fifth scaling factor based on the fourth scaling factor and the second scaling factor indicated by the DCI; and the communication unit 1001 is further configured to: receive, based on the fifth scaling factor, the PDSCH for which TBS scaling is performed.

In some embodiments, the determining unit is further configured to: determine the fifth scaling factor based on a product of the fourth scaling factor and the second scaling factor indicated by the DCI.

In some embodiments, the determining unit is further configured to: determine a sixth scaling factor based on a first set including one or more scaling factors indicated by the first indication information or the third indication information; and the communication unit 1001 is further configured to: receive, based on the sixth scaling factor, the PDSCH for which TBS scaling is performed.

In some embodiments, the determining unit is further configured to: determine a seventh scaling factor based on the sixth scaling factor and the second scaling factor indicated by the DCI; and the communication unit 1001 is further configured to: receive, based on the seventh scaling factor, the PDSCH for which TBS scaling is performed.

In some embodiments, the determining unit is further configured to: determine the seventh scaling factor based on a product of the sixth scaling factor and the second scaling factor indicated by the DCI.

In some embodiments, the determining unit is further configured to: determine an eighth scaling factor based on a second set including one or more scaling factors. Herein the second set is specified in a protocol, or the second set is determined by the terminal device according to pre-configuration, or the second set is a set of default values; and the communication unit 1001 is further configured to: receive, based on the eighth scaling factor, the PDSCH for which TBS scaling is performed.

In some embodiments, the determining unit is further configured to: determine a ninth scaling factor based on the eighth scaling factor and the second scaling factor indicated by the DCI; and the communication unit 1001 is further configured to: receive, based on the ninth scaling factor, the PDSCH for which TBS scaling is performed.

In some embodiments, the determining unit is further configured to: determine the ninth scaling factor based on a product of the eighth scaling factor and the second scaling factor indicated by the DCI.

In some embodiments, the sixth TBS scaling factor and/or the eighth TBS scaling factor is determined according to an indication of the DCI for scheduling the PDSCH.

In some embodiments, the sixth TBS scaling factor and/or the eighth TBS scaling factor is determined according to an indication of the first TB scaling domain in the DCI for scheduling the PDSCH.

In some embodiments, the sixth TBS scaling factor and/or the eighth TBS scaling factor is determined according to an indication of a modulation coding scheme (MCS) domain in the DCI for scheduling the PDSCH.

In some embodiments, the MCS domain includes a first bit and a second bit; the first bit indicates the sixth TBS scaling factor and/or the eighth TBS scaling factor, and the second bit indicates an MCS corresponding to the PDSCH.

In other embodiments, the first bit is a first number of most significant bits (MSBs), and the second bit is a second number of least significant bits (LSBs).

Alternatively, the first bit is the first number of least significant bits (LSBs), and the second bit is the second number of most significant bits (MSBs).

In some embodiments, the first bit is 2 most significant bits (MSBs), and the second bit is 3 least significant bits (LSBs).

Alternatively, the first bit is 2 LSBs, and the second bit is 3 MSBs.

In some embodiments, the communication apparatus 1000 further includes an obtaining unit. The obtaining unit is configured to obtain an MCS index set. The second bit indicates an MCS corresponding to the PDSCH in the MCS index set.

In some embodiments, the sixth TBS scaling factor and/or the eighth TBS scaling factor is determined according to an indication of one or more reserved bits in the DCI for scheduling the PDSCH.

Alternatively, the one or more reserved bits in the DCI for scheduling the PDSCH are configured as a second TB scaling domain, and the sixth TBS scaling factor and/or the eighth TBS scaling factor is determined according to an indication of the second TB scaling domain.

In some embodiments, the second indication information is carried through a physical random access channel (PRACH).

In some embodiments, the communication unit 1001 is further configured to: send the PRACH on a first random access resource; and indicate, through the PRACH corresponding to the first random access resource, a request for TBS scaling for the PDSCH or a request for a new TBS scaling factor.

In some embodiments, the communication unit 1001 is further configured to: send the PRACH corresponding to a first PRACH format; and indicate, through the PRACH corresponding to the first PRACH format, a request for TBS scaling for the PDSCH or a request for a new TBS scaling factor.

In some embodiments, the communication unit 1001 is further configured to: send the PRACH within a first random access channel occasion (RO); and indicate, through the PRACH corresponding to the first RO, a request for TBS scaling for the PDSCH or a request for a new TBS scaling factor.

In some embodiments, the communication unit 1001 is further configured to: send the PRACH including a first PRACH preamble; and indicate, through the PRACH including the first PRACH preamble, a request for TBS scaling for the PDSCH or a request for a new TBS scaling factor.

In some embodiments, at least one of the first random access resource, the first PRACH format, the first RO, or the first PRACH preamble is specified in the protocol, or is determined by the terminal device according to pre-configuration, or is configured by the network device to the terminal device.

In some embodiments, the communication unit 1001 is further configured to: send the second indication information in the case that a measured value of a reference signal is less than or equal to a threshold, and/or the terminal device has a capability to receive the PDSCH for which TBS scaling is performed.

In some embodiments, the DCI for scheduling the PDSCH contains the first transport block (TB) scaling domain, and/or, the downlink control information (DCI) for scheduling the PDSCH is scrambled by at least one of the following: a paging-radio network temporary identifier (P-RNTI), a random access-radio network temporary identifier (RA-RNTI), or a MsgB-radio network temporary identifier (MsgB-RNTI).

Alternatively, the DCI for scheduling the PDSCH does not contain the first TB scaling domain, and/or, the DCI for scheduling the PDSCH is scrambled by at least one of the following: a cell-radio network temporary identifier (C-RNTI), a configured scheduling-radio network temporary identifier (CS-RNTI), a modulation coding scheme-cell-radio network temporary identifier (MCS-C-RNTI), a temporary cell-radio network temporary identifier (TC-RNTI), or a system information-radio network temporary identifier (SI-RNTI).

FIG. 11 is a second schematic structural composition diagram of a communication apparatus provided by an embodiment of the present disclosure. As illustrated in FIG. 11, the communication apparatus 1100 includes a communication unit 1101. The communication unit 1101 is configured to send system information. Herein the system information carries first indication information. The communication unit 1101 is further configured to send downlink control information (DCI) for scheduling a physical downlink shared channel (PDSCH). Here, the first indication information and/or the DCI are used for the terminal device to receive the PDSCH for which transport block size (TBS) scaling is performed.

In some embodiments, the first indication information indicates one or more TBS scaling factors for the PDSCH; or, the first indication information does not indicate the one or more TBS scaling factors for the PDSCH.

In some embodiments, the DCI includes a first TB scaling domain. Herein the first TB scaling domain indicates one or more TBS scaling factors for the PDSCH or an invalid value, and the invalid value is an invalid TBS scaling factor or is null; or, the DCI does not include the first TB scaling domain.

In some embodiments, the communication unit 1101 is further configured to receive second indication information. The second indication information is used to request transport block size (TBS) scaling for the physical downlink shared channel (PDSCH), or to request a new TBS scaling factor.

The communication unit 1101 is further configured to send third indication information.

Herein the third indication information and/or the DCI are used for the terminal device to receive the PDSCH for which transport block size (TBS) scaling is performed.

In some embodiments, the first indication information or the third indication information indicates a first scaling factor; and the first scaling factor is used for the terminal device to receive the PDSCH for which TBS scaling is performed.

In some embodiments, the DCI indicates a second scaling factor; and the second scaling factor is used for the terminal device to receive the PDSCH for which TBS scaling is performed.

In some embodiments, the first indication information or the third indication information indicates the first scaling factor, and the DCI carries the second scaling factor, where the first scaling factor and the second scaling factor are used for the terminal device to receive the PDSCH for which TBS scaling is performed.

In some embodiments, the first indication information and/or the DCI is used for the terminal device to receive, based on a fourth scaling factor, the PDSCH for which TBS scaling is performed. Here the fourth scaling factor is a positive number with a value range greater than 0 and less than or equal to 1.

In some embodiments, the first indication information and/or the DCI is used for the terminal device to receive, based on the fourth scaling factor and the second scaling factor indicated by the DCI, the PDSCH for which TBS scaling is performed.

In some embodiments, the first indication information or the third indication information indicates a first set including one or more scaling factors; and the first set is used for the terminal device to determine a sixth scaling factor and receive, based on the sixth scaling factor, the PDSCH for which TBS scaling is performed.

In some embodiments, the first set is used for the terminal device to determine the sixth scaling factor, and receive, based on the sixth scaling factor and the second scaling factor indicated by the DCI, the PDSCH for which TBS scaling is performed.

In some embodiments, the first indication information and/or the DCI is used for the terminal device to determine an eighth scaling factor based on a second set including one or more scaling factors, and receive, based on the eighth scaling factor, the PDSCH for which TBS scaling is performed

Herein the second set is specified in a protocol, or the second set is determined by the terminal device according to pre-configuration, or the second set is a set of default values.

In some embodiments, the first indication information and/or the DCI is used for the terminal device to determine the eighth scaling factor based on the second set including one or more scaling factors, and receive, based on the eighth scaling factor and the second scaling factor indicated by the DCI, the PDSCH for which TBS scaling is performed.

In some embodiments, the sixth TBS scaling factor and/or the eighth TBS scaling factor is determined according to an indication of the DCI for scheduling the PDSCH.

In some embodiments, the sixth TBS scaling factor and/or the eighth TBS scaling factor is determined according to an indication of the first TB scaling domain in the DCI for scheduling the PDSCH.

In some embodiments, the sixth TBS scaling factor and/or the eighth TBS scaling factor is determined according to an indication of a modulation coding scheme (MCS) domain in the DCI for scheduling the PDSCH.

In some embodiments, the MCS domain includes a first bit and a second bit; the first bit indicates the sixth TBS scaling factor and/or the eighth TBS scaling factor, and the second bit indicates an MCS corresponding to the PDSCH.

In other embodiments, the first bit is a first number of most significant bits (MSBs), and the second bit is a second number of least significant bits (LSBs).

Alternatively, the first bit is the first number of least significant bits (LSBs), and the second bit is the second number of most significant bits (MSBs).

In some embodiments, the first bit is 2 most significant bits (MSBs), and the second bit is 3 least significant bits (LSBs).

Alternatively, the first bit is 2 least significant bits (LSBs), and the second bit is 3 most significant bits (MSBs).

In some embodiments, the communication unit 1101 is further configured to send an MCS index set. The second bit indicates an MCS corresponding to the PDSCH in the MCS index set.

In some embodiments, the sixth TBS scaling factor and/or the eighth TBS scaling factor is determined according to an indication of one or more reserved bits in the DCI for scheduling the PDSCH.

Alternatively, the one or more reserved bits in the DCI for scheduling the PDSCH are configured as a second TB scaling domain, and the sixth TBS scaling factor and/or the eighth TBS scaling factor is determined according to an indication of the second TB scaling domain.

In some embodiments, the second indication information is carried through a physical random access channel (PRACH).

In some embodiments, the communication unit 1101 is further configured to: receive the PRACH on a first random access resource, where the PRACH corresponding to the first random access resource indicates a request for TBS scaling for the PDSCH or a request for a new TBS scaling factor.

In some embodiments, the communication unit 1101 is further configured to: receive the PRACH corresponding to a first PRACH format, where the PRACH corresponding to the first PRACH format indicates a request for TBS scaling for the PDSCH or a request for a new TBS scaling factor.

In some embodiments, the communication unit 1101 is further configured to: receive the PRACH within a first random access channel occasion (RO), where the PRACH corresponding to the first RO indicates a request for TBS scaling for the PDSCH or a request for a new TBS scaling factor.

In some embodiments, the communication unit 1101 is further configured to: receive the PRACH including a first PRACH preamble, where the PRACH including the first PRACH preamble indicates a request for TBS scaling for the PDSCH or a request for a new TBS scaling factor.

In some embodiments, at least one of the first random access resource, the first PRACH format, the first RO, or the first PRACH preamble is specified in the protocol, or is determined by the terminal device according to pre-configuration, or is configured by the network device to the terminal device.

In some embodiments, the DCI for scheduling the PDSCH contains the first transport block (TB) scaling domain; and/or, the DCI for scheduling the PDSCH is scrambled by at least one of the following: a paging-radio network temporary identifier (P-RNTI), a random access-radio network temporary identifier (RA-RNTI), or a MsgB-radio network temporary identifier (MsgB-RNTI).

Alternatively, the DCI for scheduling the PDSCH does not contain the first TB scaling domain; and/or, the DCI for scheduling the PDSCH is scrambled by at least one of the following: a cell-radio network temporary identifier (C-RNTI), a configured scheduling-radio network temporary identifier (CS-RNTI), a modulation coding scheme-cell-radio network temporary identifier (MCS-C-RNTI), a temporary cell-radio network temporary identifier (TC-RNTI), or a system information-radio network temporary identifier (SI-RNTI).

Those skilled in the art should understand that the relevant description of the above communication apparatus in embodiments of the present disclosure may be understood by referring to the relevant description of the communication method in embodiments of the present disclosure.

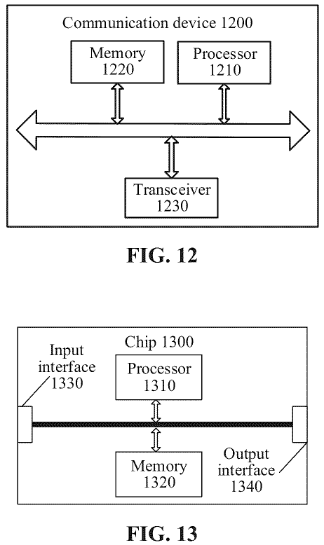

FIG. 12 is a schematic structural diagram of a communication device provided by an embodiment of the present disclosure. The communication device may be a terminal device or a network device. The communication device 1200 illustrated in FIG. 12 includes a processor 1210, and the processor 1210 may invoke and run a computer program from a memory to implement the method in embodiments of the present disclosure.

In an example, as illustrated in FIG. 12, the communication device 1200 may further include a memory 1220. Herein, the processor 1210 may invoke and run a computer program from the memory 1220 to implement the method in embodiments of the present disclosure.

Herein, the memory 1220 may be a separate device independent of the processor 1210, or may be integrated into the processor 1210.

In an example, as illustrated in FIG. 12, the communication device 1200 may further include a transceiver 1230, the processor 1210 may control the transceiver 1230 to communicate with other devices, and in particular, may send information or data to other devices, or receive information or data sent from other devices.

Herein, the transceiver 1230 may include a transmitter and a receiver. The transceiver 1230 may further include antennas, the number of which may be one or more.

In an example, the communication device 1200 may specifically be the terminal device or the network device of embodiments of the present disclosure, and the communication device 1200 may implement the corresponding flows implemented by the terminal device or the network device in various methods of embodiments of the present disclosure, which will not be repeated here for the sake of brevity.

FIG. 13 is a schematic structural diagram of a chip of an embodiment of the present disclosure. The chip 1300 illustrated in FIG. 13 includes a processor 1310, and the processor 1310 may invoke and run a computer program from a memory to implement the method in embodiments of the present disclosure.

In an example, as illustrated in FIG. 13, the chip 1300 may further include a memory 1320. Herein, the processor 1310 may invoke and run a computer program from the memory 1320 to implement the method in embodiments of the present disclosure.

Herein, the memory 1320 may be a separate device independent of the processor 1310, or may be integrated into the processor 1310.

In an example, the chip 1300 may further include an input interface 1330. Herein, the processor 1310 may control the input interface 1330 to communicate with other devices or chips, and in particular, may acquire information or data sent from other devices or chips.

In an example, the chip 1300 may further include an output interface 1340. Herein, the processor 1310 may control the output interface 1340 to communicate with other devices or chips, and in particular, may output information or data to other devices or chips.

In an example, the chip may be applied to the terminal device or the network device of embodiments of the present disclosure, and the chip may implement the corresponding flows implemented by the terminal device or the network device in various methods of embodiments of the present disclosure, which will not repeated herein for the sake of brevity.

It should be understood that the chip referred to in embodiments of the present disclosure may also be referred to as a system level chip, a system on chip, a chip system, or a system on a chip, etc.

An embodiment of the present disclosure further provides a computer program product. The computer program product includes a computer storage medium storing a computer program. The computer program includes instructions executable by at least one processor, and the instructions, when executed by the at least one processor, implement the communication method in any embodiment of the present disclosure.

In some embodiments, the computer program product may be applied to the terminal device or the network device in embodiments of the present disclosure, and the computer program instructions cause the computer to perform the corresponding flows implemented by the terminal device or the network device in various methods of embodiments of the present disclosure, which will not repeated herein for simplicity.

In an example, the computer program product in embodiments of the present disclosure may also be referred to as a software product in other embodiments.

An embodiment of the present disclosure further provides a computer program, which causes a computer to perform the communication method of any embodiment of the present disclosure.

In some embodiments, the computer program may be applied to the terminal device or the network device in embodiments of the present disclosure, and when running on a computer, the computer program causes the computer to perform the corresponding flows implemented by the terminal device or the network device in various methods of embodiments of the present disclosure, which will not repeated herein for simplicity.

The processor, the communication apparatus, or the chip of embodiments of the present disclosure may be an integrated circuit chip with signal processing capability. In implementation, the respective operations of the above method embodiments may be accomplished by integrated logic circuits of hardware in the processor or by instructions in the form of software. The above mentioned processor, communication apparatus, or chip may include the integration of any one or more of the following: a general-purpose processor, an application specific integrated circuit (ASIC), a digital signal processor (DSP), a digital signal processing device (DSPD), a programmable logic device (PLD), a field programmable gate array (FPGA), a central processing unit (CPU), a graphics processing unit (GPU), an embedded neural-network processing unit (NPU), a controller, a microcontroller, a microprocessor, a programmable logic device, a discrete gate or a transistor logic device, or a discrete hardware component. The various methods, operations and logic diagrams disclosed in embodiments of the present disclosure may be implemented or performed. The general purpose processor may be a microprocessor, or the processor may be any conventional processor or the like. The operations of the method disclosed in combination with embodiments of the present disclosure may be directly embodied as being performed by a hardware decoding processor or a combination of the hardware and software modules in the decoding processor. The software module may be located in random access memory (RAM), flash memory, read-only memory (ROM), programmable ROM (PROM), or electrically erasable programmable memory, registers and other storage medium mature in the art. The storage medium is located in the memory, and the processor reads the information in the memory and completes the operations in the above methods in conjunction with its hardware.

It can be understood that the memory or the computer storage medium in embodiments of the present disclosure may be volatile memory or non-volatile memory or may include both volatile and non-volatile memory. Herein, the non-volatile memory may be ROM, PROM, erasable PROM (EPROM), electrically EPROM (EEPROM), or flash memory. The volatile memory may be a random access memory (RAM) which serves as an external cache. By way of illustration, but not limitation, many forms of RAM are available, such as static RAM (SRAM), dynamic RAM (DRAM), synchronous DRAM (SDRAM), double data rate SDRAM (DDR SDRAM), enhanced SDRAM (ESDRAM), synchlink DRAM (SLDRAM), and direct rambus RAM (DR RAM). It should be noted that the memory of the system and method described in the present disclosure is intended to include but not to limit these and any other suitable types of memory.

It should be understood that the above-mentioned memory or computer storage medium is exemplary, but not limiting. For example, the memory in embodiments of the present disclosure may also be static RAM (SRAM), dynamic RAM (DRAM), synchronous DRAM (SDRAM), double data rate SDRAM (DDR SDRAM), enhanced SDRAM (ESDRAM), synch link DRAM (SLDRAM), and direct rambus RAM (DR RAM), etc. That is to say, the memory in embodiments of the present disclosure is intended to include but not to limit these and any other suitable types of memory.

Those skilled in the art will appreciate that the various example units and algorithm operations described in conjunction with embodiments disclosed in the present disclosure can be implemented in electronic hardware or a combination of computer software and electronic hardware. Whether these functions are performed in the hardware or software form depends on the specific application and design constraints of the technical solution. Those skilled in the art may use different methods for each particular application to implement the described function, but such implementation should not be considered beyond the scope of the present disclosure.

Those skilled in the art will clearly appreciate that, for convenience and brevity of description, specific working processes of the above-described systems, apparatuses, and units may refer to corresponding processes in the foregoing method embodiments, which will not be repeated herein.

In several embodiments provided by the present disclosure, it should be understood that the disclosed systems, apparatuses and methods may be implemented in other ways. For example, the above-described apparatus embodiments are only exemplary. For example, the partition of units is only a logical functional partition, which may be implemented in another way, for example, multiple units or components may be combined or integrated into another system, or some features may be ignored or not performed. On the other hand, the coupling, direct coupling or communication connection between each other shown or discussed above may be indirect coupling or communication connection through some interfaces, devices or units, and may be electrical, mechanical or other form.

The units illustrated as separate components may or may not be physically separated, and components displayed as units may or may not be physical units, i.e., may be located in one place, or may be distributed over multiple network units. Some or all of the units may be selected according to actual needs to achieve the object of embodiments of the present disclosure.

In addition, each functional unit in each embodiment of the present disclosure may be integrated in one processing unit, each unit may exist physically alone, or two or more units may be integrated in one unit.

In any embodiment of the present disclosure, the time interval, time period, duration range, within the duration, or time window, etc., may include both endpoint times, or may include only a part of the endpoint times (for example, including the left endpoint time but not the right endpoint time, or including the right endpoint time but not the left endpoint time), or may not include the endpoint times at all.

The functions may be stored in a computer readable storage medium if implemented in the form of software functional units and sold or used as independent products. Based on such understanding, the technical solution of the present disclosure, in essence or a part contributing to the prior art, or a part of the technical solution, may be embodied in the form of a software product. The computer program product is stored in a storage medium and includes several instructions for causing a computer device (which may be a personal computer, server, or network device, etc.) to perform all or part of the operations of the method of respective embodiments of the present disclosure. The aforementioned storage medium includes various mediums capable of storing program codes such as U disk, mobile hard disk, read-only memory (ROM), random access memory (RAM), magnetic disk or optical disk.

The above-mentioned is only the specific implementation of the present disclosure, but the scope of protection of the present disclosure is not limited thereto. Any changes or substitutions may be easily think of by those skilled familiar with the art within the technical scope disclosed by the present disclosure, should be covered within the scope of protection of the present disclosure. Therefore, the scope of protection of the present disclosure shall be subject to the scope of protection of the claims.

1. A method for communication, comprising:
receiving, by a terminal device, system information, wherein the system information carries first indication information;
receiving, by the terminal device, downlink control information (DCI) for scheduling a physical downlink shared channel (PDSCH); and
receiving, by the terminal device based on at least one of the first indication information or the DCI, the PDSCH for which transport block size (TBS) scaling is performed,
wherein the first indication information indicates one or more TBS scaling factors for the PDSCH; or the first indication information does not indicate one or more TBS scaling factors for the PDSCH; and
wherein the DCI comprises a first transport block (TB) scaling domain, wherein the first TB scaling domain indicates one or more TBS scaling factors for the PDSCH or an invalid value, the invalid value being an invalid TBS scaling factor or being null; or
the DCI does not comprise a first TB scaling domain.

2. The method of claim 1, wherein receiving, by the terminal device based on at least one of the first indication information or the DCI, the PDSCH for which TBS scaling is performed comprises:
sending, by the terminal device, second indication information based on at least one of the first indication information, a measured value of a reference signal, or the terminal device having a capability to receive the PDSCH for which TBS scaling is performed, wherein the second indication information is used to request TBS scaling for a PDSCH, or to request a new TBS scaling factor;
receiving, by the terminal device, third indication information; and
receiving, by the terminal device based on at least one of the third indication information or the DCI, the PDSCH for which TBS scaling is performed.

3. The method of claim 1, wherein receiving, by the terminal device, the PDSCH for which TBS scaling is performed comprises:
receiving, by the terminal device based on a first scaling factor indicated by the first indication information or third indication information, the PDSCH for which TBS scaling is performed; or
receiving, by the terminal device based on a second scaling factor indicated by the DCI, the PDSCH for which TBS scaling is performed; or
receiving, by the terminal device based on a first scaling factor indicated by the first indication information or third indication information and a second scaling factor indicated by the DCI, the PDSCH for which TBS scaling is performed.

4. The method of claim 1, wherein receiving, by the terminal device, the PDSCH for which TBS scaling is performed comprises:
determining, by the terminal device, a fifth scaling factor based on a fourth scaling factor and a second scaling factor indicated by the DCI; and
receiving, by the terminal device based on the fifth scaling factor, the PDSCH for which TBS scaling is performed,
wherein the fourth scaling factor is a positive number greater than 0 and less than or equal to 1.

5. The method of claim 1, wherein receiving, by the terminal device, the PDSCH for which TBS scaling is performed comprises one of the following:
determining, by the terminal device, a sixth scaling factor based on a first set comprising one or more scaling factors indicated by the first indication information or third indication information; and receiving, by the terminal device based on the sixth scaling factor, the PDSCH for which TBS scaling is performed;
determining, by the terminal device, a sixth scaling factor based on a first set comprising one or more scaling factors indicated by the first indication information or third indication information; determining, by the terminal device, a seventh scaling factor based on the sixth scaling factor and a second scaling factor indicated by the DCI; and receiving, by the terminal device based on the seventh scaling factor, the PDSCH for which TBS scaling is performed;
determining, by the terminal device, an eighth scaling factor based on a second set comprising one or more scaling factors, wherein the second set is specified in a protocol, or the second set is determined by the terminal device according to pre-configuration, or the second set is a set of default values; and receiving, by the terminal device based on the eighth scaling factor, the PDSCH for which TBS scaling is performed; or
determining, by the terminal device, an eighth scaling factor based on a second set comprising one or more scaling factors, wherein the second set is specified in a protocol, or the second set is determined by the terminal device according to pre-configuration, or the second set is a set of default values; determining, by the terminal device, a ninth scaling factor based on the eighth scaling factor and a second scaling factor indicated by the DCI; and receiving, by the terminal device based on the ninth scaling factor, the PDSCH for which TBS scaling is performed.

6. The method of claim 5, wherein at least one of a sixth TBS scaling factor or an eighth TBS scaling factor is determined according to an indication of the DCI for scheduling the PDSCH.

7. The method of claim 5, wherein at least one of a sixth TBS scaling factor or an eighth TBS scaling factor is determined according to an indication of a modulation coding scheme (MCS) domain in the DCI for scheduling the PDSCH,
wherein the MCS domain comprises a first bit and a second bit, the first bit indicating at least one of the sixth TBS scaling factor or the eighth TBS scaling factor, and the second bit indicating an MCS corresponding to the PDSCH;
wherein one of the following applies:
the first bit is a first number of most significant bits (MSBs), and the second bit is a second number of least significant bits (LSBs); or
the first bit is a first number of LSBs, and the second bit is a second number of MSBs; and
wherein the method further comprises:
obtaining, by the terminal device, an MCS index set, wherein the second bit indicates an MCS corresponding to the PDSCH in the MCS index set.

8. The method of claim 2, wherein the second indication information is carried through a physical random access channel (PRACH);
wherein sending, by the terminal device, the second indication information comprises at least one of the following:
sending, by the terminal device, the PRACH on a first random access resource; and indicating, through the PRACH corresponding to the first random access resource, a request for TBS scaling for the PDSCH or a request for a new TBS scaling factor;
sending, by the terminal device, the PRACH corresponding to a first PRACH format; and indicating, through the PRACH corresponding to the first PRACH format, a request for TBS scaling for the PDSCH or a request for a new TBS scaling factor;
sending, by the terminal device, the PRACH within a first random access channel occasion (RO); and indicating, through the PRACH corresponding to the first RO, a request for TBS scaling for the PDSCH or a request for a new TBS scaling factor; or
sending, by the terminal device, the PRACH comprising a first PRACH preamble; and indicating, through the PRACH comprising the first PRACH preamble, a request for TBS scaling for the PDSCH or a request for a new TBS scaling factor,
wherein at least one of the first random access resource, a first PRACH format, a first RO, or a first PRACH preamble is specified in a protocol, or is determined by the terminal device according to pre-configuration, or is configured by a network device to the terminal device.

9. A method for communication, comprising:
sending, by a network device, system information, wherein the system information carries first indication information; and
sending, by the network device, downlink control information (DCI) for scheduling a physical downlink shared channel (PDSCH),
wherein at least one of the first indication information or the DCI is used for a terminal device to receive the PDSCH for which transport block size (TBS) scaling is performed,
wherein the first indication information indicates one or more TBS scaling factors for the PDSCH; or the first indication information does not indicate one or more TBS scaling factors for the PDSCH; and
wherein the DCI comprises a first transport block (TB) scaling domain, wherein the first TB scaling domain indicates one or more TBS scaling factors for the PDSCH or an invalid value, the invalid value being an invalid TBS scaling factor or being null; or
the DCI does not comprise a first TB scaling domain.

10. The method of claim 9, further comprising:
receiving, by the network device, second indication information, wherein the second indication information is used to request TBS scaling for a PDSCH, or to request a new TBS scaling factor; and
sending, by the network device, third indication information,
wherein at least one of the third indication information or the DCI is used for the terminal device to receive the PDSCH for which TBS scaling is performed.

11. The method of claim 9, wherein one of the following applies:
the first indication information or third indication information indicates a first scaling factor, the first scaling factor being used for the terminal device to receive the PDSCH for which TBS scaling is performed;
the DCI indicates a second scaling factor, the second scaling factor being used for the terminal device to receive the PDSCH for which TBS scaling is performed;
the first indication information or third indication information indicates a first scaling factor, and the DCI carries a second scaling factor, the first scaling factor and the second scaling factor being used for the terminal device to receive the PDSCH for which TBS scaling is performed;
the at least one of the first indication information or the DCI is used for the terminal device to receive, based on a fourth scaling factor, the PDSCH for which TBS scaling is performed, the fourth scaling factor being a positive number greater than 0 and less than or equal to 1;
the first indication information or third indication information indicates a first set comprising one or more scaling factors, the first set being used for the terminal device to determine a sixth scaling factor and receive, based on the sixth scaling factor, the PDSCH for which TBS scaling is performed; or
the at least one of the first indication information or the DCI is used for the terminal device to determine an eighth scaling factor based on a second set comprising one or more scaling factors, and receive, based on the eighth scaling factor, the PDSCH for which TBS scaling is performed, wherein the second set is specified in a protocol, or the second set is determined by the terminal device according to pre-configuration, or the second set is a set of default values.

12. The method of claim 10, wherein the second indication information is carried through a physical random access channel (PRACH); and
wherein receiving, by the network device, the second indication information comprises at least one of the following:
receiving, by the network device, the PRACH on a first random access resource, wherein the PRACH corresponding to the first random access resource indicates a request for TBS scaling for the PDSCH or a request for a new TBS scaling factor;
receiving, by the network device, the PRACH corresponding to a first PRACH format, wherein the PRACH corresponding to the first PRACH format indicates a request for TBS scaling for the PDSCH or a request for a new TBS scaling factor;
receiving, by the network device, the PRACH within a first random access channel occasion (RO), wherein the PRACH corresponding to the first RO indicates the request for TBS scaling for the PDSCH or the request for a new TBS scaling factor; or
receiving, by the network device, the PRACH comprising a first PRACH preamble, wherein the PRACH comprising the first PRACH preamble indicates the request for TBS scaling for the PDSCH or the request for a new TBS scaling factor,
wherein at least one of the first random access resource, a first PRACH format, a first RO, or a first PRACH preamble is specified in a protocol, or is determined by the terminal device according to pre-configuration, or is configured by the network device to the terminal device.

13. The method of claim 9, wherein
at least one of the following applies:
the DCI for scheduling the PDSCH includes a first transport block (TB) scaling domain; or
the DCI for scheduling the PDSCH is scrambled by at least one of the following: a paging-radio network temporary identifier (P-RNTI), a random access-radio network temporary identifier (RA-RNTI), or a MsgB-radio network temporary identifier (MsgB-RNTI); or
at least one of the following applies:
the DCI for scheduling the PDSCH does not include a first TB scaling domain; or
the DCI for scheduling the PDSCH is scrambled by at least one of the following: a cell-radio network temporary identifier (C-RNTI), a configured scheduling-radio network temporary identifier (CS-RNTI), a modulation coding scheme-cell-radio network temporary identifier (MCS-C-RNTI), a temporary cell-radio network temporary identifier (TC-RNTI), or a system information-radio network temporary identifier (SI-RNTI).

14. A terminal device, comprising:
a memory for storing a computer program executable by a processor; and
the processor,
wherein the processor is configured to, when executing the program, perform operations comprising:
receiving system information, wherein the system information carries first indication information;
receiving downlink control information (DCI) for scheduling a physical downlink shared channel (PDSCH); and
receiving, based on at least one of the first indication information or the DCI, the PDSCH for which transport block size (TBS) scaling is performed,
wherein the first indication information indicates one or more TBS scaling factors for the PDSCH; or the first indication information does not indicate one or more TBS scaling factors for the PDSCH; and
wherein the DCI comprises a first transport block (TB) scaling domain, wherein the first TB scaling domain indicates one or more TBS scaling factors for the PDSCH or an invalid value, the invalid value being an invalid TBS scaling factor or being null; or
the DCI does not comprise a first TB scaling domain.

15. The terminal device of claim 14, wherein the processor is configured to, when executing the program, perform operations further comprising:
sending second indication information based on at least one of the first indication information, a measured value of a reference signal, or the terminal device having a capability to receive the PDSCH for which TBS scaling is performed, wherein the second indication information is used to request TBS scaling for a PDSCH, or to request a new TBS scaling factor;
receiving third indication information; and
receiving, based on at least one of the third indication information or the DCI, the PDSCH for which TBS scaling is performed.

16. The terminal device of claim 14, wherein the processor is configured to, when executing the program, perform operations further comprising:
receiving, based on a first scaling factor indicated by the first indication information or third indication information, the PDSCH for which TBS scaling is performed; or
receiving, based on a second scaling factor indicated by the DCI, the PDSCH for which TBS scaling is performed; or
receiving, based on a first scaling factor indicated by the first indication information or third indication information and a second scaling factor indicated by the DCI, the PDSCH for which TBS scaling is performed; or
determining a fifth scaling factor based on a fourth scaling factor and a second scaling factor indicated by the DCI; and receiving, based on the fifth scaling factor, the PDSCH for which TBS scaling is performed, wherein the fourth scaling factor is a positive number greater than 0 and less than or equal to 1; or
determining a sixth scaling factor based on a first set comprising one or more scaling factors indicated by the first indication information or third indication information; and receiving, based on the sixth scaling factor, the PDSCH for which TBS scaling is performed; or
determining a sixth scaling factor based on a first set comprising one or more scaling factors indicated by the first indication information or third indication information; determining a seventh scaling factor based on the sixth scaling factor and a second scaling factor indicated by the DCI; and receiving, based on the seventh scaling factor, the PDSCH for which TBS scaling is performed; or
determining an eighth scaling factor based on a second set comprising one or more scaling factors, wherein the second set is specified in a protocol, or the second set is determined by the terminal device according to pre-configuration, or the second set is a set of default values; and receiving, based on the eighth scaling factor, the PDSCH for which TBS scaling is performed; or
determining, an eighth scaling factor based on a second set comprising one or more scaling factors, wherein the second set is specified in a protocol, or the second set is determined by the terminal device according to pre-configuration, or the second set is a set of default values; determining a ninth scaling factor based on the eighth scaling factor and a second scaling factor indicated by the DCI; and receiving, based on the ninth scaling factor, the PDSCH for which TBS scaling is performed.

17. The terminal device of claim 16, wherein
at least one of a sixth TBS scaling factor or an eighth TBS scaling factor is determined according to an indication of a first TB scaling domain in the DCI for scheduling the PDSCH; or
at least one of a sixth TBS scaling factor or an eighth TBS scaling factor is determined according to an indication of one or more reserved bits in the DCI for scheduling the PDSCH; or
one or more reserved bits in the DCI for scheduling the PDSCH are configured as a second TB scaling domain, and at least one of a sixth TBS scaling factor or an eighth TBS scaling factor is determined according to an indication of the second TB scaling domain.

18. The terminal device of claim 16, wherein at least one of a sixth TBS scaling factor or an eighth TBS scaling factor is determined according to an indication of a modulation coding scheme (MCS) domain in the DCI for scheduling the PDSCH,
wherein the MCS domain comprises a first bit and a second bit, the first bit indicating at least one of the sixth TBS scaling factor or the eighth TBS scaling factor, and the second bit indicating an MCS corresponding to the PDSCH;
wherein one of the following applies:
the first bit is a first number of most significant bits (MSBs), and the second bit is a second number of least significant bits (LSBs); or
the first bit is a first number of LSBs, and the second bit is a second number of MSBs; and
wherein the processor is further configured to perform operations comprising:
obtaining an MCS index set, wherein the second bit indicates an MCS corresponding to the PDSCH in the MCS index set.

19. The terminal device of claim 15, wherein the second indication information is carried through a physical random access channel (PRACH);
wherein the processor is further configured to perform operations comprising at least one of the following:
sending the PRACH on a first random access resource; and indicating, through the PRACH corresponding to the first random access resource, a request for TBS scaling for the PDSCH or a request for a new TBS scaling factor;
sending the PRACH corresponding to a first PRACH format; and indicating, through the PRACH corresponding to the first PRACH format, a request for TBS scaling for the PDSCH or a request for a new TBS scaling factor;
sending the PRACH within a first random access channel occasion (RO); and indicating, through the PRACH corresponding to the first RO, a request for TBS scaling for the PDSCH or a request for a new TBS scaling factor; or
sending the PRACH comprising a first PRACH preamble; and indicating, through the PRACH comprising the first PRACH preamble, a request for TBS scaling for the PDSCH or a request for a new TBS scaling factor,
wherein at least one of the first random access resource, a first PRACH format, a first RO, or a first PRACH preamble is specified in a protocol, or is determined by the terminal device according to pre-configuration, or is configured by a network device to the terminal device.

20. The terminal device of claim 14, wherein
at least one of the following applies:
the DCI for scheduling the PDSCH includes a first transport block (TB) scaling domain; or
the DCI for scheduling the PDSCH is scrambled by at least one of the following: a paging-radio network temporary identifier (P-RNTI), a random access-radio network temporary identifier (RA-RNTI), or a MsgB-radio network temporary identifier (MsgB-RNTI); or
at least one of the following applies:
the DCI for scheduling the PDSCH does not include a first TB scaling domain; or
the DCI for scheduling the PDSCH is scrambled by at least one of the following: a cell-radio network temporary identifier (C-RNTI), a configured scheduling-radio network temporary identifier (CS-RNTI), a modulation coding scheme-cell-radio network temporary identifier (MCS-C-RNTI), a temporary cell-radio network temporary identifier (TC-RNTI), or a system information-radio network temporary identifier (SI-RNTI).
